(19) United States
(12) Patent Application Publication
(10) Pub. No.: US 2018/0059259 A1
(43) Pub. Date: Mar. 1, 2018

(54) METHOD AND DEVICE FOR DETECTING RADIOELEMENTS

(71) Applicant: COMMISSARIAT A L'ENERGIE ATOMIQUE ET AUX ENERGIES AL TERNATIVES, PARIS (FR)

(72) Inventors: Frédérick CARREL, GIF-SUR-YVETTE (FR); Eric BARAT, LIMOURS (FR); Thomas DAUTREMER, PALAISEAU (FR); Matthieu HAMEL, CHERBOURG-OCTEVILLE (FR); Stéphane NORMAND, ISIGNY LE BUAT (FR)

(21) Appl. No.: 15/560,480

(22) PCT Filed: Mar. 22, 2016
(86) PCT No.: PCT/EP2016/056208

§ 371 Date: Sep. 21, 2017

(30) Foreign Application Priority Data
Mar. 24, 2015 (FR) 1552415

(51) Int. Cl. G01T 1/178; G01T 1/20

(52) U.S. Cl. CPC G01T 1/178; G01T 1/2018

(57) ABSTRACT

A method for determining the nature of the radioelements present in an object and their activity comprises at least the following steps: a first phase of numerical simulation of spectrometric responses for an incident-energy set E and a measured-output-energy set E′, so as to obtain a simulated-data set, a second phase of non-parametric regression on the simulated data, non-parametric estimation of the quantity representing the joint probability of the triplets (E,E′,y) on the basis of simulated points (Ei,Ei′,yij) so as to deduce therefrom a meta-model S(E, E′) for any energy pair (E, E′) on a continuous function, on the basis of the meta-model S(E, E′), the determination of the nature and activity of the radioelements present in the object.

The subject of the invention relates to a method and a device for detecting radioelements contained in an object and for determining their nature and their activity. It makes it possible in particular to take account of parasitic effects originating from the environment in which the object to be analyzed is situated.

Gamma spectrometry is a technique making it possible to detect the gamma radiations emitted spontaneously by radioelements. This technique makes it possible to identify the gamma emitter radioelements and to measure their activity. To attain qualitative and quantitative objectives, the processing of a gamma spectrum is based on the analysis of the peaks present in the spectrum. These correspond to the gamma radiation emitted by a specific radioelement, for example ¹³⁷Cs emitting a gamma at 661.5 keV or ⁶⁰Co emitting a gamma at 1173.2 keV and a gamma at 1332.5 keV. The presence of a peak in a gamma spectrum signifies that the energy of the incident gamma radiation has been entirely absorbed in the detector, subsequent to one or more interactions, photoelectric effect, Compton effect or production of pairs, having taken place within the detector.

The detectors used to carry out gamma spectrometry measurements can be separated into two categories: scintillators and semi-conductors. The quality of a gamma spectrum can be evaluated by virtue of two parameters specific to the detector used: the resolution in terms of energy, that is to say the capacity to separate two peaks that are close together in terms of energy defined as being the mid-height width of a peak present in the spectrum at a given energy, and the detection efficiency, the denser the material, the more considerable the probability of absorbing the entirety of the incident gamma radiation. These two parameters vary significantly as a function of the detector used.

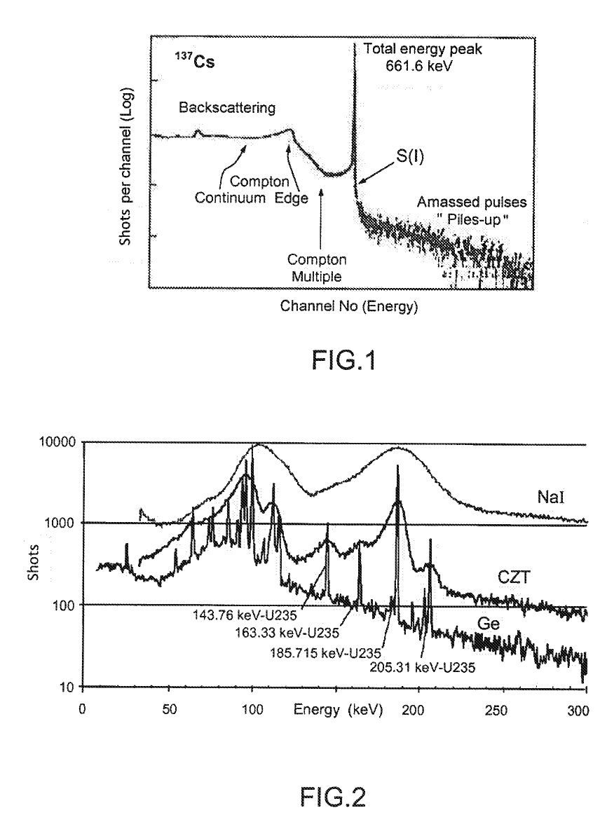

Inorganic scintillators (Nal, BGO) benefit from degraded resolution relative to semi-conductor detectors (CZT or HPGe). Nonetheless, they generally exhibit greater detection efficiency. Indeed, because of their low cost, it is possible to manufacture them with large dimensions. FIG. 1 shows, in a Channel energy chart, clicks per channel, an exemplary spectrum S(I) obtained with the aid of an HPGe detector and of a ¹³⁷Cs source emitting gamma radiation at 661.5 keV. FIG. 2 compares S(HPGe), S(CZT), S(Nal) spectra obtained with the aid of a uranium sample and various types of detectors, exhibiting different performance levels in terms of energy resolution.

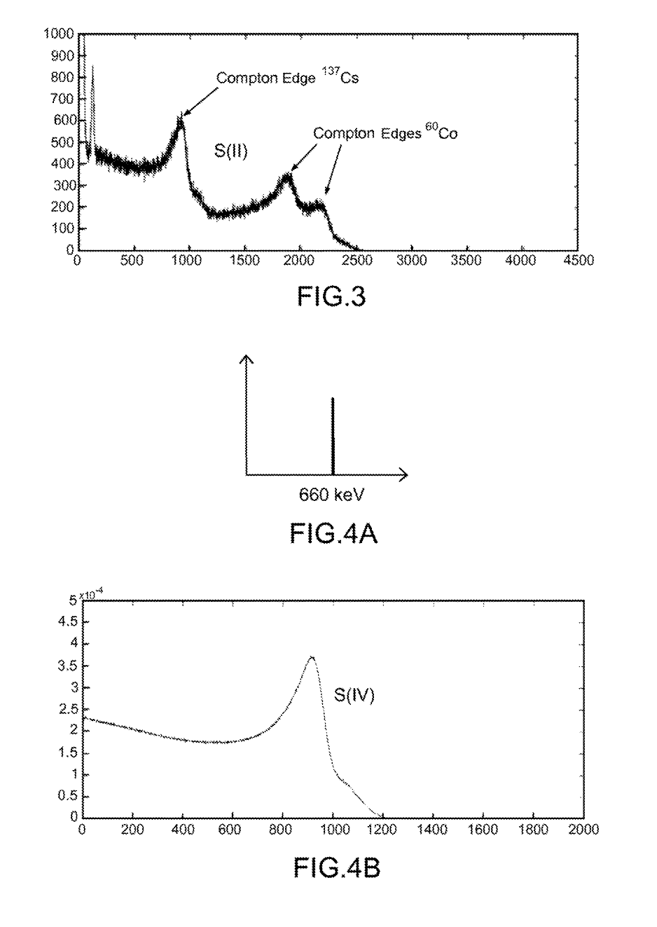

It is also known to use plastic scintillators to detect gamma radiations. The cost of manufacture of such scintillators being fairly low, they can be manufactured with large dimensions for various types of application. On account of their intrinsic characteristics and in spite of their very considerable dimensions relative to other detectors, the probability of an incident photon depositing all its energy within a detector through the photoelectric effect is extremely low. FIG. 3 shows a spectrum S(II) obtained with the aid of a plastic scintillator of type EJ200, in the presence of ⁶⁰Co and ¹³⁷Cs sources. The characteristic shapes of these spectra are due to the Compton edges pursuant to interactions within the detector. Thus, the absence of photoelectric peaks characteristic of the presence of ¹³⁷Cs and of ⁶⁰Co may be noted. For this reason, these detectors are generally used to carry out measurements of total count, detection of all the gamma radiations interacting within the detector without any information about their energy. A traditional approach consisting in measuring the net area of the various peaks of interest is therefore not conceivable and an alternative solution must be employed if it is desired to undertake the identification of the radioelements present in the spectrum.

A solution for processing a gamma spectrum, identifying the emitter radioelements and measuring their activity consists in analyzing the spectrum as a whole and not in restricting oneself solely to the analysis of the photoelectric peaks. The approach followed consists in expressing the analysis of the spectrum in the following matrix form:

S=H.A, with

S: a signal matrix, matrix with dimensions (numb_channels, 1), where the variable numb_channels is equal to the number of channels of the gamma spectrum,

A: an activity matrix, matrix with dimensions (numb_incident_energies, 1). The variable numb_incident_energies corresponds to the number, defined by the user, of incident energies which is taken into consideration in the reconstruction. These incident energies correspond to the number of elementary volume elements of a conventional emission tomography problem,

H: a projector of the problem, matrix with dimensions (numb_channels, numb_incident_energies). This matrix comprises the set of detection efficiencies involved in the problem. By way of example, an element hij of this matrix corresponds to the probability that a photon with incident energy j is detected in channel i of the gamma spectrum.

The signal matrix S corresponds to the result of the measurement, to the gamma spectrum to be analyzed, the projector matrix is generally computed by simulation, the matrix A corresponds to the result of the reconstruction.

FIG. 4A and FIG. 4B illustrate an exemplary notion of projector H, for an incident energy of 660 keV, FIG. 4A. The spectrum S(IV) of FIG. 4B corresponds to the incident energy corresponding to an entire column of the projector H. The projector therefore contains the spectral response of the detector for each incident energy taken into consideration in the problem and defined by the user. It is on this grid of incident energies that the reconstruction step will be performed.

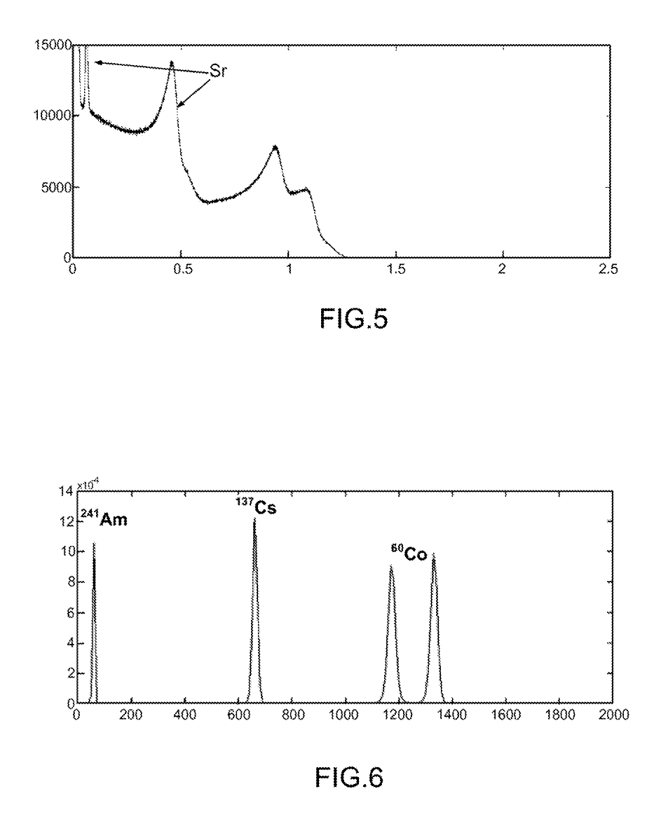

Various schemes make it possible to take into consideration the whole of the gamma spectrum so as to undertake a qualitative and quantitative analysis, allowing the identification of the radioelements present in the spectrum and the activity of the radioelement present in the spectrum of incident energies. This analysis methodology is illustrated in FIGS. 5 and 6. FIG. 5 represents the gamma spectrum to be analyzed, corresponding to a simulation of the response of a plastic scintillator of type EJ200, in the presence of three gamma sources (²⁴¹Am, ¹³⁷Cs, ⁶⁰Co). The spectrum Sr reconstructed on the basis of the results of the analysis and of the incident energies is represented by dotted line in the figure. FIG. 6 illustrates the result of a reconstruction performed with the aid of an algorithm of ML-EM type, the incident energies reconstructed on the basis of the spectrum of FIG. 5.

Despite all their interest and advantages, the traditional analysis schemes exhibit a few limitations. One of the intrinsic limitations is related to the discrete character of the grid chosen to perform the reconstruction and obtain the incident energies. In all the conventional approaches, like that of ML-EM type, this grid is discrete, following a spacing defined by the user. This spacing is one of the limitations during the reconstruction step since it will be possible to reconstruct only on the initially defined grid. The spacing between each incident energy can be adapted as a function of the complexity of the problem treated. A fine spacing will allow greater fineness during reconstruction, but will have a direct impact on the computation of the projector. The latter generally being computed by simulation, a finer spacing will translate into an increase in computation time, the latter possibly becoming prohibitive for certain applications.

An alternative would consist in seeking the solutions in the form of a discrete spectrum whose support is a continuous space. In order to be integratable within the framework of an ML-EM algorithm, such an approach would demand the computation of the projector on the fly by Monte-Carlo simulation for each incident energy in the course of the iterations of the algorithm. Since the incident energy values evolve as dictated by the iterations, computations of responses are required at each iteration without it being possible for the previously computed values to be reused. The order of magnitude of computation of such an approach turns out to be prohibitive for current computers.

In the reconstruction of ML-EM type, no a priori is introduced during the reconstruction step. In respect of the representativity of the projector, one of the main limitations of this type of approach is related to the representativity of the projector used during reconstruction. The projector is generally obtained subsequent to a simulation step, with the aid of a model describing the detector used and its environment. Nonetheless, it is generally difficult to achieve fine modeling, knowledge of the geometry of the detector, limitations of the computation code which model the interactions within the detector only imperfectly, absence of consideration of certain physical phenomena, such as the collection of visible photons for example in the case of plastic scintillators. If the modeling of the detector and/or of the environment is imperfect, a greater or lesser bias will be present during reconstruction.

Rather than considering a grid of incident energies on which the reconstruction would be performed, another approach is to use a database. In this case, instead of simulating a grid of incident energies, the signature of a given element is simulated directly, for example for ⁶⁰Co, the response of the detector will be simulated directly for two incident energies, emitted respectively at 1173.2 keV and 1332.5 keV. With this approach the reconstruction is performed directly on a grid of radioelements. It also exhibits the advantage of converging more rapidly than the approach with grid, since the number of components to be taken into consideration is smaller. One of the drawbacks of this scheme is its limitation to the consideration of only the radioelements initially present in the database. If the analysis of a gamma spectrum involves a radioelement that is absent from the database, the reconstruction will be erroneous.

In the subsequent description, the expression “input spectrum” designates a set of incident energies that are defined by a user and the expression “output spectrum” designates a set of measured energies. The word meta-data and the word projector designate one and the same object.

The invention relates to a method for determining the nature of the radioelements present in an object and their activity, characterized in that it comprises at least the following steps:

a first phase of numerical simulation of spectrometric responses for an incident-energy set E and a measured-output-energy set E′, so as to obtain a simulated-data set,

a second phase of non-parametric regression on the simulated data, non-parametric estimation of the quantity representing the joint probability of the triplets (E,E′,y) on the basis of simulated points (Ei,Ei′,yij) so as to deduce therefrom a meta-model S(E, E′) for any energy pair (E, E′) on a continuous function,

on the basis of the meta-model S(E, E′), the determination of the nature and activity of the radioelements present in the object.

According to a variant embodiment, the method comprises the following steps:

use is made of n a number of points in the input grid, energies E, and n′ a number of points in the output grid, energies E′,

for i=1, . . . , n and j=1, . . . , n′, the data characteristic of the computed spectral intensities λᵢⱼ for an input energy Eᵢ and an output energy E′ⱼ are available,

use is made of a non-parametric scheme for estimating the quantity f(E, E′, y), representing the joint probability density of the triplets (E, E′, y) on the basis of the simulated points (Eᵢ,E′ⱼ, yᵢⱼ), and a model S(E, E′) is deduced for all (E, E′) ∈ [symbol] ² where [symbol] is a continuous space:

$$\begin{matrix}S ( E , {E}^{′} ) = ( y \vert E , {E}^{′} ) \\ = y \cdot f ( y \vert E , {E}^{′} ) dy = \frac{ y \cdot f ( y \vert E , {E}^{′} ) dy}{ f ( y \vert E , {E}^{′} ) dy}\end{matrix}$$

where the symbol [symbol] (y) represents the mathematical expectation of the random variable y, y is deduced from the computed spectral intensities λᵢⱼ.

It is possible to determine the values λᵢⱼ by using a Monte-Carlo software package, the data λᵢⱼ being considered to be realizations arising from a Poisson distribution whose intensity Iᵢⱼ is estimated by means of a non-parametric regression procedure and we introduce yᵢⱼ=log(λᵢⱼ+ε) where 0<ε<<1, and then

the probability distribution of yᵢⱼ for sufficiently large values of Iᵢⱼ>10 is approximated by a Gaussian law with mean log Iᵢⱼ and with variance

$$\frac{1}{{I}_{ij}} ,$$

for the joint law f(E, E′, y), a Dirichlet process mixture (DPM) is chosen as a priori distribution and the random distribution is expressed as

a sum over infinity of f_{θ}_{ₖ} the components of f(E, E′, y),

$$f ( E , {E}^{′} , y ) = {\sum }_{k = 1}^{∞} {w}_{k} {f}_{{θ}_{k}} ( E , {E}^{′} , y )$$

parametrized by θₖ the parameter associated with the k^{th} component of G a random measure defined by

$$G ( \cdot ) = {\sum }_{k = 1}^{∞} {w}_{k} {δ}_{{θ}_{k}} ( \cdot )$$

with w₁=V₁, wₖ=VₖΠₗ₌₁^{k-1}(1−Vₗ) such that Vₖ˜Beta(1, α) and δᵤ(•) represents the localized Dirac function in u and Beta(a, b), for 0≦x≦1 with

$${f}_{Beta ( a , b )} ( x ) = \frac{Γ ( a + b )}{Γ ( a ) Γ ( b )} {{x}^{a - 1} ( 1 - x )}^{b - 1} .$$

The components of the joint law f_{θ}_{ₖ} are, for example, expressed on the basis of the following values:
θₖ=(\vec{μ}ₖ, \vec{τ}ₖ, Ψₖ, βₖ) with \vec{μ}ₖ=(μₖ, μ′ₖ), \vec{τ}ₖ=(τₖ, τ′ₖ),

\tilde{X}ₖ(\vec{E}) the centered vector of regressors with \vec{E}=(E, E′) and βₖ the vector of regression coefficients,

the matrix Σₖ, dependent on the parameter Ψₖ ∈ {0,1}, as follows:

$${Σ}_{k} = {R}_{{ψ}_{k}}^{- 1} \cdot ( \begin{matrix}{τ}_{k} & 0 \\ 0 & {τ}_{k}^{′}\end{matrix} ) \cdot {R}_{{ψ}_{k}} with {R}_{{ψ}_{k}} = ( \begin{matrix}1 & 0 \\ 0 & 1\end{matrix} ) if {ψ}_{k} = 0 and$$

$${R}_{{ψ}_{k}} = \frac{\sqrt{2}}{2} ( \begin{matrix}1 & - 1 \\ 1 & 1\end{matrix} ) if {ψ}_{k} = 1 ,$$

making it possible to choose between a component aligned with the axes E and E′ (Ψₖ=0) and an oblique component oriented by the straight line E=E′(Ψₖ=1), each component f_{θ}_{ₖ} is then expressed:

f_{θ}_{ₖ}(E, E′, y)= [symbol] ₂(\vec{E}|\vec{μ}ₖ, Σₖ)N(y|βₖ^{T}·\tilde{X}ₖ(\vec{E}), e^{-β}^{ₖ}^{^{T}}^{·\tilde{X}}^{ₖ}^{(\vec{E})})

where [symbol] (·|μ, σ²) represents the Gaussian law of μ and of variance σ², [symbol] ₂(·|\vec{μ}, Σ) the bivariate Gaussian law with mean \vec{μ} ∈ [symbol] ² and with covariance matrix Σ, where the a priori law for the parameter μₖ is a Gaussian, the variance σₖ is distributed according to an inverse-gamma law, Ψₖ follows an a priori law of Bernoulli type and the a priori for the regression coefficients coefficients βₖ is a multivariate normal (Gaussian) law of dimension |\tilde{X}(\vec{E})|, and
by applying a Bayes' rule to the expression for f (E, E′, y) we obtain the expression

$$f ( y \vert E , {E}^{′} ) = {\sum }_{k = 1}^{∞} \frac{{w}_{k} {2}_{} ( {E}^{->} \vert {{μ}^{->}}_{k} , {Σ}_{k} )}{{\sum }_{l = 1}^{∞} {w}_{l} {2}_{} ( {E}^{->} \vert {{μ}^{->}}_{l} , {Σ}_{l} )} ( y \vert {β}_{k}^{T} \cdot {\tilde{X}}_{k} ( {E}^{->} ) , {e}^{- {β}_{k}^{T} \cdot {\tilde{X}}_{k} ( {E}^{->} )} )$$

and the probabilistic model

$$S ( E , {E}^{′} ) = ( y \vert E , {E}^{′} ) = {\sum }_{k = 1}^{∞} \frac{{w}_{k} {2}_{} ( {E}^{->} \vert {{μ}^{->}}_{k} , {Σ}_{k} )}{{\sum }_{l = 1}^{∞} {w}_{l} {2}_{} ( {E}^{->} \vert {{μ}^{->}}_{l} , {Σ}_{l} )} {β}_{k}^{′} \cdot {\tilde{X}}_{k} ( {E}^{->} )$$

on the basis of this probabilistic model and of the data observed by simulation (Eᵢ, E′ⱼ, yᵢⱼ), we estimate the a posteriori law f(E, E′, y|E₁, E′₁, y₁₁, . . . , Eₙ, E′_{n′}, y_{nn′}) and the conditional expectation Ŝ(E, E′)=E (y|E, E′, E₁, E′₁, y₁₁, . . . , Eₙ, E′_{n′}, y_{nn′}) so as to determine the elements present in the object and their activity.

For the computation of the a posteriori, use will be made of, for example, a Markov chain Monte-Carlo (MCMC) approximation scheme, for any iteration (t) of the MCMC procedure, a denoised spectral response S(E, E′)^{(t)} is generated, for T generations, the a posteriori distribution of the spectral response is approximated by the set of draws S(E, E′)^{( t)} for t=1, . . . , T, and the estimated response is expressed:

$$\hat{S} ( E , {E}^{′} ) \approx \frac{1}{T} {\sum }_{t = 1}^{T} S {( E , {E}^{′} )}^{( t )}$$

The approximation scheme can comprise a step of slice-wise sampling using a finite random number κ of components for each iteration and in that it comprises the following steps:

we introduce latent classification variables Kᵢⱼ, defined for i=1, . . . , n and j=1, . . . , n′, such that Kᵢ=k if (Eᵢ, E′ⱼ, yᵢⱼ) is distributed according to the k^{th} component of the mixture f (E, E′,y), we define a model for the parameters of the mixture,

for all i≦n, j≦n′,

$${K}_{ij} \vert {W}_{1} , {w}_{2} , … \text{\textasciitilde} {\sum }_{k = 1}^{∞} {w}_{k} {δ}_{k} ( \cdot )$$

$${E}_{i} , {E}_{j}^{′} \vert {K}_{ij} , {θ}_{1} , {θ}_{2} , … \text{\textasciitilde} {2}_{} ( {E}_{i} , {E}_{j}^{′} \vert {{μ}^{->}}_{{K}_{ij}} , {Σ}_{{K}_{ij}} )$$

$$with {{μ}^{->}}_{{K}_{ij}} = ( {μ}_{{K}_{ij}} , {μ}_{{K}_{ij}}^{′} ) , {Σ}_{{K}_{ij}} = {R}_{{ψ}_{{K}_{ij}}}^{- 1} \cdot ( \begin{matrix}{τ}_{{K}_{ij}} & 0 \\ 0 & {τ}_{{K}_{ij}}^{′}\end{matrix} ) \cdot {R}_{{ψ}_{{K}_{ij}}}$$

$${y}_{ij} \vert {K}_{ij} , {E}_{i} , {E}_{j}^{′} , {θ}_{1} , {θ}_{2} , … \text{\textasciitilde} ( {y}_{ij} \vert {β}_{{K}_{ij}}^{T} \cdot {\tilde{X}}_{{K}_{ij}} ( {E}_{i} , {E}_{j}^{′} ) , {e}^{- {β}_{{K}_{ij}}^{T} \cdot {\tilde{X}}_{{K}_{ij}} ( {E}_{i} , {E}_{j}^{′} )} )$$

equivalent to the likelihood

f(K₁₁, . . . , K_{nn′}, E₁, E′₁, . . . , Eₙ, E′_{n′}, y₁₁, . . . , y_{nn′}|w₁, w₂, . . . , θ₁, θ₂, . . . )
on the basis of these probability distributions and by applying Bayes' rule, we compute the conditional probability density

f(w₁, w₂, . . . , θ₁, θ₂, . . . |k₁₁, . . . , K_{nn′}, E₁, E′₁, . . . , Eₙ, E′_{n′}, y₁₁, . . . , y_{nn′})
by using a Gibbs sampler which at each iteration (t) successively generates the following samples, for all k,

w₁, w₂, . . . |K₁₁, . . . , K_{nn′}

Ψₖ|μₖ, μ′_{k′}K₁₁, . . . , K_{nn′}, E₁, E′₁, . . . , Eₙ, E′_{n′}

τₖ|μₖ, μ′ₖ, Ψₖ, K₁₁, . . . , K_{nn′}, E₁, E′₁, . . . , Eₙ, E′_{n′}

τ′ₖ|μₖ, μ′ₖ, Ψₖ, K₁₁, . . . , K_{nn′}, E₁, E′₁, . . . , Eₙ, E′_{n′}

μₖ, μ′ₖ51 τₖ, τ′ₖ, Ψₖ, K₁₁, . . . , K_{nn′}, E₁, E′₁, . . . , Eₙ, E′_{n′}

μₖ|μₖ, μ′ₖ, τₖ, τ′ₖ, Ψₖ, K₁₁, . . . , K_{nn′}, E₁, E′₁, . . . , Eₙ, E′_{n′}, y₁₁, . . . , y_{nn′}
and at the level of the numbers of points i in the energy input grid and of points j in the output grid, for all i≦n, j≦n′,

Kᵢⱼ|Eᵢ, E′ⱼ, yᵢⱼ, μ₁, μ₂, . . . , μ′₁, μ′₂, . . . , τ₁, τ₂, . . . , τ′₁, τ^{′}₂, . . . , β₁, β₂, . . . , Ψ₁, Ψ₂, . . . , w₁, w₂, . . .

on the basis of T iterations of the Gibbs sampler, we obtain an estimation of the meta-model for the spectrometry

$$\hat{S} ( E , {E}^{′} ) \approx \frac{1}{T} {\sum }_{t = 1}^{T} {S ( E , {E}^{′} )}^{( t )}$$

It is possible to introduce an auxiliary variable uⱼⱼ so as to generate only a finite random number κ of components at the iteration (t) while avoiding an arbitrary truncation of the model.

The method can comprise a step of computing the a posteriori standard deviation and credible intervals on the basis of the set {S(E, E′)^{(t)}}

$${σ}_{\hat{S} ( E , {E}^{′} )} \approx {( \frac{1}{T - 1} {\sum }_{t = 1}^{T} {( \hat{S} ( E , {E}^{′} ) - {S ( E , {E}^{′} )}^{( t )} )}^{2} )}^{\frac{1}{2}}$$

According to a variant embodiment, an a priori Gamma(φ_{b}, ξ_{b}) on the scale parameters b₉₆ and b′_{τ} is introduced into the distribution of the amplitudes of components leading to a Gamma a posteriori distribution:

$${b}_{τ} \text{\textasciitilde} Gamma ( {ϕ}_{b} + {κ}_{n} , {ξ}_{b} + {\sum }_{k = 1}^{{κ}_{n}} \frac{1}{{τ}_{k}} )$$

with Gamma(a, b), for x≧0,

$${f}_{Gamma ( a , b )} ( x ) = \frac{{b}^{a}}{Γ ( a )} {x}^{a - 1} {e}^{- bx}$$

The Gaussian a priori on the regression coefficients βₖ can be replaced with an a priori based on the random drawing of P points (\tilde{E}₁, [symbol] ₁, . . . , \tilde{E}_{P}, [symbol] _{P}) on the basis of [symbol] ₂(\vec{μ}ₖ, Σₖ) and we take for (\tilde{y}₁, . . . , \tilde{y}_{P}) the closest value of yᵢⱼ corresponding to each sampled point where P is larger than the size of the vector βₖ, we then generate βₖ μ [symbol] (M_{β}, Γ_{β}) as a priori law (with \vec{E}ₚ=(\tilde{E}ₚ, \tilde{E}′ₚ))

$${Γ}_{β} = {( {\sum }_{p = 1}^{P} {{\tilde{X}}_{k} ( {{E}^{->}}_{p} )}^{T} \cdot {\tilde{X}}_{k} ( {{E}^{->}}_{p} ) \cdot {e}^{- {\tilde{y}}_{p}} )}^{- 1}$$

$${M}_{β} = {Γ}_{β} \cdot ( {\sum }_{p = 1}^{P} {\tilde{X}}_{k} ( {{E}^{->}}_{p} ) {\tilde{y}}_{p} {e}^{- {\tilde{y}}_{p}} )$$

According to a variant embodiment, the method generates an extended meta-model denoted S(E, E′, ξ) where ξ is a parameter identified by an integer index and characteristic of a matrix effect.

The method can estimate the activity of the radioelements by executing the following steps:

let N_{χ} be the number of emitters retained for the element χ considered and let π_{χ,l} for l=1, . . . , N_{χ} be the associated emission probabilities and let v_{χ,l} for l=1, . . . , N_{χ} be the corresponding energies,

the response of the radionuclide Ψ_{χ}(E′, ξ), for an observed energy E′ and a matrix effect ξ, is defined by

$${ψ}_{𝒳 , ξ} ( {E}^{′} ) = {\sum }_{l = 1}^{{N}_{𝒳}} {π}_{𝒳 , l} S ( {v}_{𝒳 , l} , {E}^{′} , ξ )$$

we define

$${𝒳 , ξ}_{} = {\int }_{0}^{∞} {ψ}_{𝒳 , ξ} ( {E}^{′} ) d {E}^{′} and {π}_{𝒳 , l , ξ}^{*} = \frac{{π}_{𝒳 , 1}}{{Λ}_{𝒳 , ξ}} for all l = 1 , … , {N}_{𝒳} ,$$

we define a normalized radionuclide response by

$${ψ}_{𝒳 , ξ}^{*} ( {E}^{′} ) = {\sum }_{l = 1}^{{N}_{𝒳}} {π}_{𝒳 , l , ξ}^{*} S ( {v}_{𝒳 , l} , {E}^{′} , ξ )$$

it may be verified that ∫₀^{∞} Ψ*_{χ,ξ}(E′) dE′=1 the probability density of the i^{th} photon observed in the energy channel E′ᵢ for i=1, . . . , n is expressed

$$f ( {E}_{i}^{′} ) = {\sum }_{k = 1}^{∞} {w}_{k} {ψ}_{𝒳 k , {ξ}_{k}}^{*} ( ρ . {E}_{i}^{′} )$$

where ρ is a positive parameter for converting the channel index into energy ( keV/channel).

We introduce the variables Kᵢ for allocating the i^{th} observed photon to a component k of the mixture.

We alternate random draws in accordance with the following conditional laws, for all i≦n,
for all k

w₁,w₂, . . . |K₁, . . . , Kₙ

χₖ|K₁, . . . , Kₙ, E′₁, . . . , E′ₙ, ξ₁, ξ₂, . . . , ρ

ξₖ|K₁, . . . , Kₙ, E′₁, . . . , E′ₙ, χ₁, χ₂, . . . , ρ

as well as

ρ|K₁, . . . , Kₙ, E′₁, . . . , E′ₙ, χ₁, χ₂, . . . , ξ₁, ξ₂, . . .

by using a finite random number of components at the iteration (t),
on the basis of T iterations of the Gibbs sampler we obtain an estimation of the radioelement activities involved in the mixture for all k,

$$\approx \frac{1}{T} {\sum }_{t = 1}^{T} {w}_{k}^{( t )} {Λ}_{𝒳 k , {ξ}_{k}}^{( t )}$$

with ρ a Gaussian a priori centered on μ_{ρ} and of standard deviation σ_{ρ}.

ρ ˜ [symbol] (ρ|μ_{ρ}, σ_{ρ}²).

We compute for example the a posteriori standard deviation of the activities by executing the following steps:

$$\approx {( \frac{1}{T - 1} {\sum }_{t = 1}^{T} {( - {w}_{ k}^{( t )} {Λ}_{ 𝒳 k , ξ k}^{( t )} )}^{2} )}^{\frac{1}{2}}$$

and/or the estimated input spectrum, deconvolved of the response of the system

$$\approx \frac{1}{T} {\sum }_{t = 1}^{T} {w}_{k}^{( t )} {\sum }_{l = 1}^{{N}_{{𝒳}_{k}^{( t )}}} {π}_{{𝒳 }_{k}^{( t )} , l , {ξ}_{k}^{( t )}}^{*} {δ}_{{v}_{{𝒳}_{k}^{( t )} , l}} ( E )$$

Other characteristics and advantages of the present invention will become more clearly apparent on reading the description which follows given by way of wholly nonlimiting illustration together with the appended figures which represent:

FIG. 1, an exemplary gamma spectrum obtained with an HPGe detector,

FIG. 2, a comparative of uranium spectra obtained with the aid of various types of detectors,

FIG. 3, an exemplary spectrum obtained with the aid of a plastic scintillator,

FIG. 4a and FIG. 4B, an exemplary incident energy at 660 keV and the spectrum measured by a plastic scintillator corresponding to this incident energy,

FIG. 5, an exemplary gamma spectrum to be analyzed and a spectrum reconstructed according to the prior art,

FIG. 6, the energies reconstructed on the basis of the spectrum presented in FIG. 5,

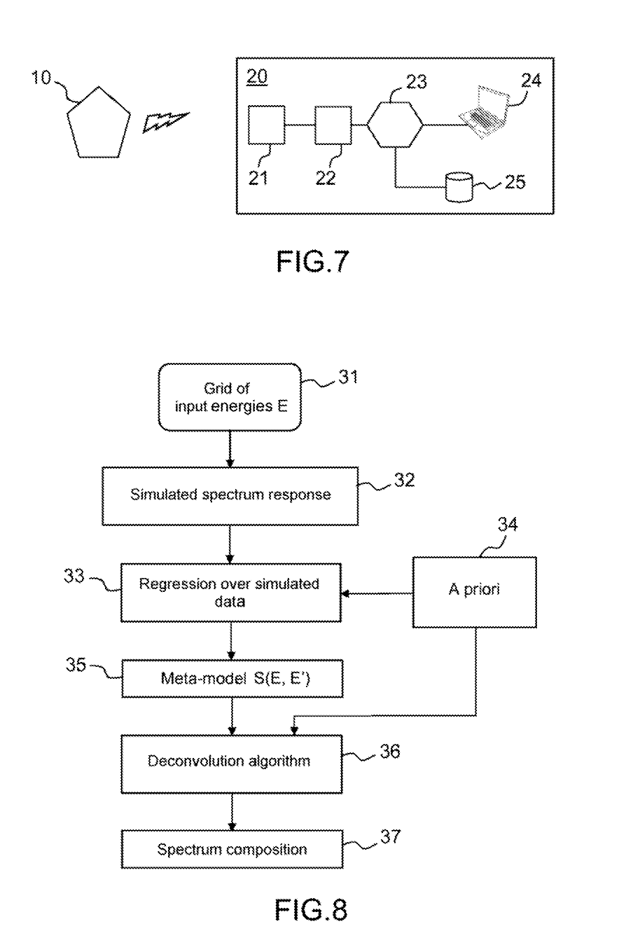

FIG. 7, an exemplary system for the implementation of the method according to the invention,

FIG. 8, a schematic of the steps implemented by the method according to the invention,

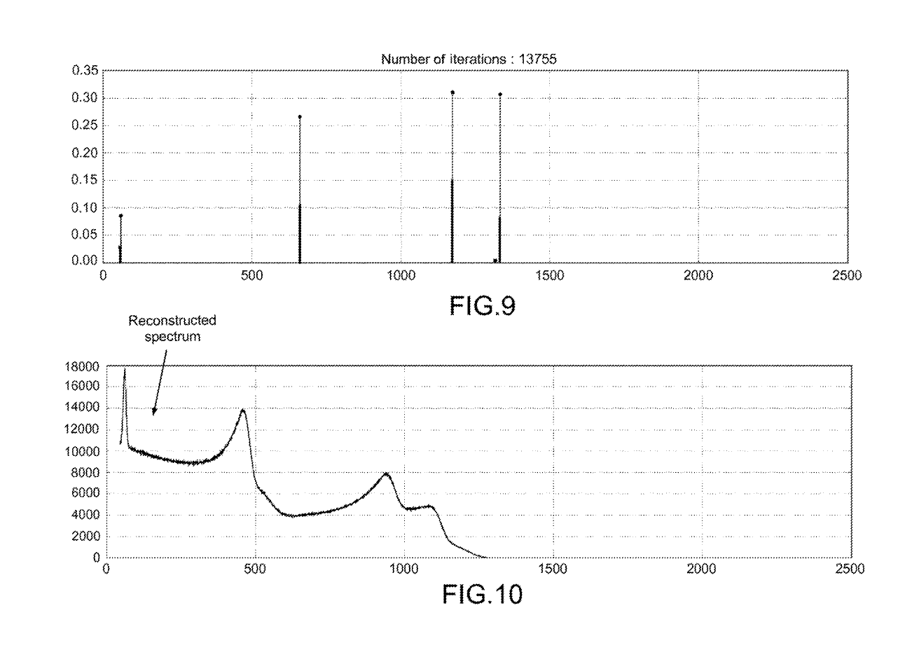

FIGS. 9 and 10, an exemplary spectrum of the incident energies, obtained by the method according to the invention,

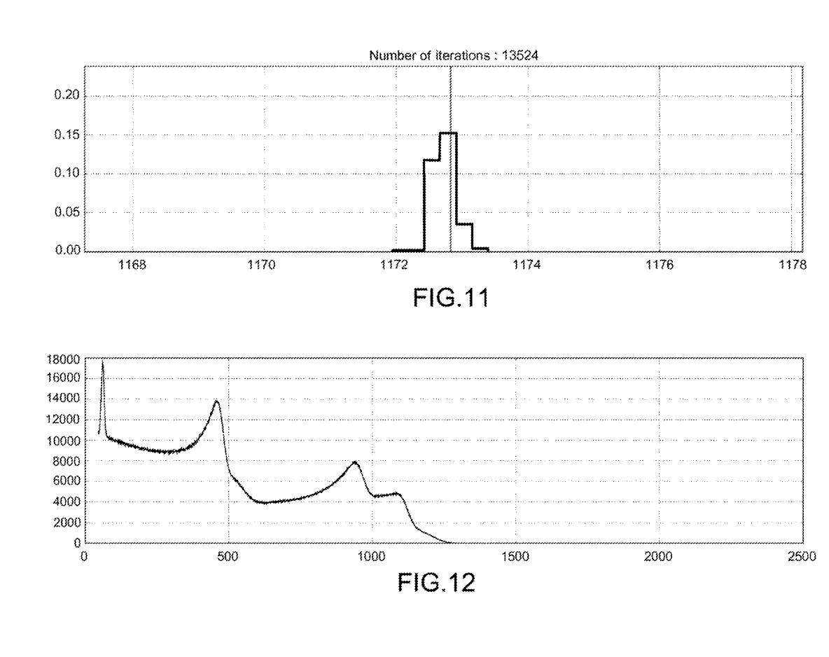

FIGS. 11 and 12, a second exemplary spectrum of the incident energies, obtained by implementing the invention.

FIG. 7 is an exemplary system allowing the implementation of the method according to the invention. The system comprises an object 10 which is likely to emit gamma radiations spontaneously due to the presence of radioactive elements. The gamma radiations are received by a device 20 comprising a radiation detection module, 21, linked to acquisition electronics making it possible to obtain a spectrum, a processor 23 or computing unit suitable for executing the steps of the method according to the invention and for processing the data of the spectrum obtained, a results display module 24, a storage means 25 for saving the results, for example. The storage means can also store the incident energies defined by a user in the context of a given application.

The method according to the invention rests notably on using all of the information present in the spectrum to be analyzed in order to carry out a succession of iterative steps for deconvolving the incident spectrum. The method uses a continuous projector or meta-model. The response of the spectrometry system will be sought through a simulation technique, computing whenever necessary the complete energy-wise response of the system for a given configuration of the input spectrum. The response of the system will be sought in the form of a discrete spectrum whose support (incident energies) is a continuous space. This continuous model will make it possible to compute the response of the spectrometry system for any incident energy E and any observed output energy E′, meta-model denoted S(E, E′). A Bayesian reconstruction step uses the meta-model to determine the radioelements contained in the object to be analyzed.

The method will comprise a first phase in the course of which a numerical simulation of spectrometric responses S, 32, will be performed for a grid of incident energies Ei, 31, followed by a second phase where a non-parametric regression (statistical prediction), 33, is applied to the simulated data. During the second phase, physical knowledge, 34, for example, will be injected in the form of a priori so as to guide the regression in regions of the incident energy where there is no simulated data. In substance, this makes it possible to indicate that on restricted energy domains, the signature of the spectral response exhibits characteristics which are either proportional to the input energy or are constant whatever the input energy Eᵢ. On the basis of the meta-model 35, and of the a priori knowledge, it will be possible to ascertain, by applying a deconvolution algorithm, 36, the composition of the spectrum 37. The chosen regression model being a non-parametric model, the method does not presume any linear or polynomial model and will thus be able to adapt to any non-linearity in the response.

The method will seek to estimate a continuous function of R² in E and E′ on the basis of a potentially infinite number of parameters, or components of the model.

To implement the method, use is made, for example, of n the number of points in the input grid (energies E) and n′ the number of points in the output grid (energies E′). For i=1, . . . , n and j=1, . . . , n′, we have data characteristic of the spectral intensities λᵢⱼ computed for an input energy Eᵢ (data defined by the user) and an output energy E′ⱼ (measured data). To illustrate the method according to the invention, it is assumed that the values λᵢⱼ have been obtained by way of a Monte-Carlo simulation software package. Consequently, the data of the spectral intensities λᵢⱼ are considered to be realizations arising from a Poisson distribution whose intensity Iᵢⱼ will be estimated by means of a non-parametric regression procedure. As λᵢⱼ is then a positive or zero quantity, we introduce yᵢⱼ =log(λᵢⱼ+ε) where 0<ε<<1. Under these conditions, the probability distribution of yᵢⱼ can be approximated for sufficiently large values of Iᵢⱼ (typically >10) by a Gaussian law with mean log Iᵢⱼ and variance

$$\frac{1}{{I}_{ij}} .$$

The Poisson distribution will be expressed in the following manner:

Distribution Poisson(λ), for n ∈ N,

$${f}_{Poisson ( λ )} ( n ) = \frac{{λ}^{n}}{n !} {e}^{- λ n}$$

The method according to the invention rests on the non-parametric estimation of the quantity f(E, E′, y), representing the joint probability density of the triplets (E, E′, y) on the basis of the simulated points (Eᵢ, Eⱼ, yᵢⱼ), so as to deduce therefrom the model S(E, E′) for all (E, E′) ∈ R² where R is a continuous space:

$$S ( E , {E}^{′} ) = ( y \vert E , {E}^{′} ) = y . f ( y \vert E , {E}^{′} ) dy = \frac{ y . f ( E , {E}^{′} , y ) dy}{ f ( E , {E}^{′} , y ) dy}$$

where the symbol E(y) represents the mathematical expectation of the random variable y, this symbol represents a statistical expectation used further on in the description to characterize the intensity of an energy in the spectrum.

For the joint law f(E, E′, y), a Dirichlet process mixture (DPM) is chosen, for example, as a priori distribution. This modeling is expressed on the basis of a random distribution G such that

G ˜ DP(α, G₀)
where the symbol “˜” signifies “is distributed in accordance with” and DP(α, G₀) represents the distribution of a Dirichlet process (Hjort N L, Holmes C, Müller P, Walker S G, Ghosal S, Lijoi A, Prünster I, The Y W, Jordan M I, Griffin J, Dunson D B and Quintana F 2010 Bayesian Nonparametrics Cambridge Series in Statistical and Probabilistic Mathematics) with a mean measure G₀ and a so-called concentration parameter α. This probability distribution over random probability distributions plays a central role in non-parametric Bayesian modeling. A commonplace representation of the DP arises from Sethuraman (1994) who expresses the random measure G(•) as:

$$G ( \cdot ) = {\sum }_{k = 1}^{∞} {w}_{k} {δ}_{{θ}_{k}} ( \cdot )$$

with w₁=V₁, wₖ=VₖΠₗ₌₁^{k-1}(1−Vₗ) such that Vₖ˜Beta(1, α) and δᵤ(•) represents the localized Dirac function in u. Here, θₖ˜G₀ represent the parameters associated with the k^{th} component of G. The non-parametric character arises from the potentially infinite number of components involved in the sum characterizing the a priori on G.

The distribution Dirichlet(α₁, α₂, . . . , α_{K}) is defined with x=(x₁, x₂, . . . , x_{K})′ ∈ R^{K}, xᵢ>0 for 1≦i≦K, Σᵢ₌₀^{K-1} xᵢ<1, x_{K}=1−Σᵢ₌₀^{K-1} xᵢ and αᵢ>0 for 1≦i≦K,

$${f}_{Dirichlet ( {α}_{1} , {α}_{2 , … ,} {α}_{K} )} ( x ) = \frac{Γ ( {α}_{1} + {α}_{2} + … + {α}_{K} )}{Γ ( {α}_{1} ) Γ ( {α}_{2} ) … Γ ( {α}_{K} )} {x}_{1}^{{α}_{1} - 1} {x}_{2}^{{α}_{2} - 1} … {x}_{K}^{K - 1} .$$

The distribution Beta(a,b), is defined for 0≦x≦1:

$${f}_{Beta ( a , b )} ( x ) = \frac{Γ ( a + b )}{Γ ( a ) Γ ( b )} {{x}^{a - 1} ( 1 - x )}^{b - 1} .$$

The random distribution f(E, E′, y) will be then expressed:

$$f ( E , {E}^{′} , y ) = {\sum }_{k = 1}^{∞} {w}_{k} {f}_{{θ}_{k}} ( E , {E}^{′} , y )$$

where f_{θ}_{ₖ} indicates the k^{th} component of f(E, E′, y), parametrized by θₖ.

The components f_{θ}_{ₖ} in the case of the application of the DPGLM to the characterization of the energy response meta-model are written by introducing the following additional notation:
θₖ=(\vec{μ}ₖ, \vec{τ}ₖ, Ψₖ, βₖ) with \vec{μ}ₖ=(μₖ, μ′ₖ), \vec{τ}ₖ=(τₖ, τ′ₖ),
\tilde{X}ₖ(\vec{E}) the centered vector of regressors with \vec{E}=(E, E′), and βₖ the vector of regression coefficients. It will be noted that the regression model for the outcome y knowing the covariables (E, E′) can be chosen linear (i.e. \tilde{X}ₖ(\vec{E})=(1, E−μₖ, E′−μ′ₖ)^{T} where v^{T} represents the transpose of the vector v) or polynomial in the DPGLM approach (e.g. \tilde{X}ₖ(\vec{E})=(1, E−μₖ, E′−μ′ₖ, (E−μₖ) (E′−μ′ₖ), (E−μₖ)², (E′−μ′ₖ)²)^{T} for a quadratic regression),
Moreover, the matrix Σₖ, dependent on the parameter Ψₖ ∈ {0,1}, is defined as follows:

$${\sum }_{k} = {R}_{{ψ}_{k}}^{- 1} \cdot ( \begin{matrix}{τ}_{k} & 0 \\ 0 & {τ}_{k}^{′}\end{matrix} ) \cdot {R}_{ψ k} with {R}_{{ψ}_{k}} = ( \begin{matrix}1 & 0 \\ 0 & 1\end{matrix} ) if {ψ}_{k} = 0 and {R}_{{ψ}_{k}} = \frac{\sqrt{2}}{2} ( \begin{matrix}1 & - 1 \\ 1 & 1\end{matrix} ) if {ψ}_{k} = 1.$$

The binary discrete variable Ψₖ thus makes it possible to choose between a component aligned with the axes E and E′(Ψₖ=0) and an oblique component oriented by the straight line E=E′(Ψₖ=1).

Furnished with this notation, each component of the random distribution is expressed as:

f_{θ}_{ₖ}(E, E′, y)= [symbol] ₂(\vec{E}|\vec{μ}ₖ, Σₖ) [symbol] (y|βₖ^{T}·\tilde{X}ₖ(\vec{E}), e^{-β}^{ₖ}^{^{T}}^{·\tilde{X}}^{ₖ}^{(\vec{E})})
where, N(•|μ, σ²) represents the Gaussian law of μ and of variance σ², N₂(•|\vec{μ}, Σ) the bivariate Gaussian law with mean \vec{μ} ∈ R² and with covariance matrix Σ.

A multivariate Gaussian distribution Nₚ(μ, Ω) is defined for x ∈ R^{p},

$${f}_{ ( μ , Ω )} ( x ) = \frac{1}{{( 2 π )}^{\frac{p}{2}} {\vert Ω \vert}^{\frac{1}{2}}} {e}^{- \frac{1}{2} {( x - μ )}^{′} \cdot {Ω}^{- 1} \cdot ( x - μ )}$$

where here |a| represents the determinant of the matrix A. Note: this definition also covers the univariate case when p=1.

The a priori measure G₀ of the Dirichlet process is chosen in the following manner. The a priori law for the parameter μₖ is a Gaussian, the variance τₖ is distributed according to an inverse-gamma law, Ψₖ follows an a priori law of Bernoulli type and the a priori for the regression coefficients of coefficients βₖ is a multivariate normal (Gaussian) law of dimension |\tilde{X}(\vec{E})|. By using Bayes' rule, we deduce from the expression for f(E, E′, y) that:

$$f ( y \vert E , {E}^{′} ) = {\sum }_{k = 1}^{∞} \frac{{w}_{k} {2}_{} ( \vec{E} \vert {\vec{μ}}_{k} , {\sum }_{k} )}{{\sum }_{l = 1}^{∞} {w}_{l} {2}_{} ( \vec{E} \vert {\vec{μ}}_{l} , {\sum }_{l} )} ( y \vert {β}_{k}^{T} \cdot {\tilde{X}}_{k} ( \vec{E} ) , {e}^{- {β}_{k}^{T} \cdot {\tilde{X}}_{k} ( \vec{E} )} ) .$$

Finally, by computing the conditional expectation E (y|E, E′) on the basis of the expression for f(y|E, E′), we obtain the expression for the spectral response model S(E, E′):

$$S ( E , {E}^{′} ) = ( y \vert E , {E}^{′} ) = {\sum }_{k = 1}^{∞} \frac{{w}_{k} {2}_{} ( \vec{E} \vert {\vec{μ}}_{k} , {\sum }_{k} )}{{\sum }_{l = 1}^{∞} {w}_{l} {2}_{} ( \vec{E} \vert {\vec{μ}}_{k} , {\sum }_{l} )} {β}_{k}^{′} \cdot {\tilde{X}}_{k} ( \vec{E} ) .$$

The latter expression makes it possible to account for the a priori corresponding to the non-parametric Bayesian approach for the denoised and interpolated spectral response.

The heteroscedastic and non-Gaussian characters at every (E, E′) are taken into consideration in the model of f(y|E, E′) by virtue of the mixture of Gaussian distributions N(y|βₖ^{T}·\tilde{X}ₖ(\vec{E}), e^{-β}^{ₖ}^{^{T}}^{·\tilde{X}}^{ₖ}^{(\vec{E})}).

On the basis of this choice of probabilistic model and of the data observed by physical simulation (Eᵢ, E′ⱼ, yᵢⱼ), the method will estimate the a posteriori law f(E, E′, y|E₁, E′₁, y₁₁, . . . , Eₙ, E′_{n′}, y_{nn′}) and the conditional expectation of this a posteriori law: Ŝ(E, E′)=E yE, E′, E₁, E′₁, y₁₁, . . . , Eₙ, E′_{n′}, y_{nn′} representing the intensity in the spectrum of an output energy E′, for any input energy E.

For the exact computation of the a posteriori distribution the method uses, for example, a Markov chain Monte-Carlo (MCMC) approximation scheme of Gibbs sampler type in order to generate samples of the target law. In order to allow the MCMC sampling procedure for objects of infinite dimension (infinity of components of the DP), the method adopts a so-called slice sampling approach in accordance with Kalli et al. (Kalli M, Griffin J E and Walker S G 2011 Slice Sampling Mixture Models, Statistics and Computing, 21, 93-105), where only a finite random number κ of components is necessary at each iteration.

For any iteration (t) of the MCMC procedure, it is thus possible to generate a denoised spectral response S(E,E′)^{(t)}. For T generations, the a posteriori distribution of the spectral response is approximated by the set of draws S(E,E′)^{(t)} for t=1, T, and the estimated response (a posteriori mean) is expressed:

$$\hat{S} ( E , {E}^{′} ) \approx \frac{1}{T} {\sum }_{t = 1}^{T} {S ( E , {E}^{′} )}^{( t )} .$$

It is also possible to compute in an analogous manner the a posteriori standard deviation and the credible intervals on the basis of the collection {S(E, E′)^{(t)}}.

An example for executing the sampling procedure according to Gibbs will now be given.

The generating model for the parameters of the DPM mixture is given by:

V₁, V₂, . . . ˜ Beta(1, α)

i.e. w₁=V₁, w₂=V₂(1−V₁), . . .

\vec{μ}₁, \vec{μ}₂, . . . ˜ [symbol] ₂(\vec{m}_{μ}, ┌_{μ})

τ₁⁻¹, τ₂⁻¹, . . . ˜ Gamma(a_{τ}, b_{τ})

[symbol]

, [symbol] , . . . ˜ Gamma(a_{τ′}, b_{τ′})

β₁, β₂, . . . ˜ [symbol] _{|\tilde{X}(\vec{E})|}(M_{β}, ┌_{β})

Ψ₁, Ψ₂, . . . ˜ Bernoulli(ρ)

i.e. θ₁=(\vec{μ}₁, \vec{τ}₁, β₁, Ψ₁), θ₂=(\vec{μ}₂, \vec{τ}₂, β₂, Ψ₂), . . .

with \vec{μ}₁=(μ₁, μ′₁), \vec{τ}₁=(τ₁, τ′₁), . . .

This generating model is entirely equivalent to the a priori probability density f(w₁, w₂, . . . , θ₁, θ₂, . . . ), and corresponds to an a priori of Dirichlet process type for the random measure G(•)=Σₖ₌₁^{∞} wₖ δ_{θ}_{ₖ}(•) ˜ DP(α, G₀).

The description of the modeling of the DPM parameters is completed with a generating model of the observed data arising from the physical simulation (Eᵢ,E′ⱼ, yᵢⱼ). Accordingly, so-called latent classification variables Kᵢⱼ are introduced, defined for i=1, . . . , n and j=1, . . . , n′, such that Kᵢ=k if (Eᵢ, E′ⱼ, yᵢⱼ) is distributed according to the k^{th} component of the mixture f(E, E′,y).

Loop over all the n input energies E and n′ energies E of the output grid For all i≦n, j≦n′,

$${K}_{ij} \vert {w}_{1} , {w}_{2} , … ∼ {\sum }_{k = 1}^{∞} {w}_{k} {δ}_{k} ( \cdot )$$

$${E}_{i} , {E}_{j}^{′} \vert {K}_{ij} , {θ}_{1} , {θ}_{2} , … {∼}_{{2}_{}} ( {E}_{i} , {E}_{j}^{′} \vert {\vec{μ}}_{{K}_{ij}} , {\sum }_{{K}_{ij}} )$$

$$with {\vec{μ}}_{{K}_{ij}} = ( {μ}_{{K}_{ij}} , {μ}_{{K}_{ij}}^{′} ) , \\ {\sum }_{{K}_{ij}} = {R}_{{ψ}_{{K}_{ij}}}^{- 1} \cdot ( \begin{matrix}{τ}_{{K}_{ij}} & 0 \\ 0 & {τ}_{{K}_{ij}}^{′}\end{matrix} ) \cdot {R}_{{ψ}_{{K}_{ij}}} \\ {y}_{ij} \vert {K}_{ij} , {E}_{i} , {E}_{j}^{′} , {θ}_{1} , {θ}_{2} , … ∼ ( {y}_{ij} \vert {β}_{{K}_{ij}}^{T} \cdot {\tilde{X}}_{{K}_{ij}} ( {E}_{i} , {E}_{j}^{′} ) , {e}^{- {β}_{{K}_{ij}}^{T} \cdot {\tilde{X}}_{{K}_{ij}} ( {E}_{i} , {E}_{j}^{′} )} ) .$$

This generating model is entirely equivalent to the likelihood:

f(K₁₁, . . . , K_{nn′}, E₁, E′₁, . . . , Eₙ, E′_{n′}, y₁₁, . . . , y_{nn′}|w₁, w₂, . . . , θ₁, θ₂, . . . ).

On the basis of these probability distributions and by applying Bayes' rule, it is sought to compute the conditional probability density

fw₁, w₂, . . . , θ₁, θ₂, . . . |K₁₁, . . . , K_{nn′}, E₁, E′₁, . . . , Eₙ, E′_{n′}, y₁₁, . . . , y_{nn′}
which represents the distribution of the weightings and parameters of the components conditionally upon the observations and upon the classification variables.

This inference is made by means of a Gibbs sampler which at each iteration (t) of the algorithm successively generates the following samples, for all k,

w₁, w₂, . . . |K₁₁, . . . , K_{nn′}

Ψₖ|μₖ, μ′ₖ, K₁₁, . . . , K_{nn′}, E₁, E′₁, . . . , Eₙ, E′_{n′}

τₖ|μₖ, μ′ₖ, Ψₖ, K₁₁, . . . , K_{nn′}, E₁, E′₁, . . . , Eₙ, E′_{n′}

τ′ₖ|μₖ, μ′ₖ, Ψₖ, K₁₁, . . . , K_{nn′}, E₁, E′₁, . . . , Eₙ, E′_{n′}

μₖ, μ′ₖ|τₖ, τ′ₖ, Ψₖ, K₁₁, . . . , K_{nn′}, E₁, E′₁, . . . , Eₙ, E′_{n′}

βₖ|μₖ, μ′ₖ, τₖ, τ′ₖ, Ψₖ, K₁₁, . . . , K_{nn′}, E₁, E′₁, . . . , Eₙ, E′_{n′}, y₁₁, . . . , y_{nn′}
and at the level of the numbers of points i in the energy input grid and of points j in the output grid, for all i≦n, j≦n′,

Kᵢⱼ|Eᵢ, E′ⱼ, yᵢⱼ, μ₁, μ₂, . . . , μ′₁, μ′₂, . . . , τ₁, τ₂, . . . , τ′₁, τ′₂, . . . , β₁, β₂, . . . Ψ₁, Ψ₂, . . . , w₁, w₂, . . .

The non-parametric behavior of the method is characterized by the potentially infinite collection of parameters wₖ and θₖ. In order to reduce the computational difficulty induced by the infinite number of parameters, it is possible to use a truncation of the DP to a sufficiently high number of components (Ishwaran and James 2001).

An alternative solution proposed by (Kalli et al. 2011) is to introduce an auxiliary variable uᵢⱼ which makes it possible to generate only a finite random number κ of components at the iteration (t) while avoiding an arbitrary truncation of the model. In this case, the various steps of random generation of the algorithm will be as follows:

Random Initialization.
Generate for 1≦i≦n, j≦n′, uᵢⱼ˜Uniform(0, 1/n.n′), and put

$${u}^{*} = {min}_{u} ( \{ {u}_{ij} \} )$$

Generate V₁˜Beta(1, α); Put w₁=V₁ and r₁=1−V₁.
For k>1, generate Vₖ˜Beta(1, α), put wₖ=Vₖrₖ₋₁, put rₖ=rₖ₋₁(1−Vₖ), as long as rₖ≧u*.
Assign the maximum value of k to κ*.

Generate 0ₖ for 1 <k <κ*, on the basis of the a priori distributions.
At iteration t=1, T,
   Generate
      (Kᵢⱼ|Eᵢ, E′ⱼ, yᵢⱼ, uᵢⱼ, μ₁, μ₂, . . . , μ′₁, μ′₂, . . . , τ₁, τ₂, . . . , τ′₁, τ′₂, . . . β₁, β₂, . . . , Ψ₁, Ψ₂, . . . , w₁, w₂, . . . ) for i≦n, j≦n′
      Compute for 1≦k≦κ*,
      λₖ=(wₖ>uᵢⱼ)max(wₖ, 1/n.n′)N₂(\vec{E}ᵢⱼ|\vec{μ}ₖ, Σₖ)N(yᵢⱼ|βₖ^{T}·\tilde{X}ₖ(\vec{E}ᵢⱼ), e^{-β}^{ₖ}^{^{T}}^{·\tilde{X}}^{ₖ}^{(\vec{E}}^{ᵢⱼ}⁾) where 1(A) is the indicator function: 1(A)=1 if A is true and 1(A)=0 otherwise.
      Generate

$${K}_{ij} \text{∼} \frac{1}{{\sum }_{k = 1}^{{K}^{*}} {λ}_{k}} {\sum }_{k = 1}^{{K}^{*}} {λ}_{k} {δ}_{k} ( {K}_{ij} ) .$$

Reorder the tags of components following their order of occurrence in the generation of the Kᵢⱼ. Assign the number of distinct values of Kᵢⱼ to Kₙ. Put, for all k≦κₙ, nₖ=#{Kᵢⱼ=k}, the number of observations yᵢⱼ which is assigned to the component k.
Generate (w₁, w₂ , u₁₁, . . . , u_{nn′}|K₁₁, . . . , K_{nn′})
   Generate (w₁, w₂, . . . , w_{κ}_{ₙ}, r_{κ}_{ₙ}) ˜ Dirichlet(n₁, n₂, . . . , n_{κ}_{ₙ}, α)
   Generate for i≦n, j≦n′, uᵢⱼ˜Uniform(0,min(wₖ, 1/n. n′))
   Put

$${u}^{*} = {min}_{u} ( \{ {u}_{ij} \} )$$

For k>κₙ, generate Vₖ˜Beta(1, α) , put wₖ=Vₖrₖ₋₁, put rₖ=rₖ₋₁(1−Vₖ), as long as rₖ≧u*.
Assign the maximum value of k to κ*.
Generate (Ψₖ|μₖ, μ′ₖ, K₁₁, . . . , K_{nn′}, E₁, E′₁, . . . , Eₙ, E′_{n′}) for k≦κ*
   Compute v₀

$$= \frac{{b}_{τ}^{{a}_{τ}} \cdot {b}_{{τ}^{′}}^{{a}_{{τ}^{′}}}}{\begin{matrix}{( {b}_{τ} + \frac{1}{2} {\sum }_{\{ i , j \text{:} {K}_{ij} = k \}} {( {E}_{{i}^{- {μ}_{k}}} )}^{2} )}^{{a}_{τ} + \frac{{n}_{k}}{2}} \\ {( {b}_{{τ}^{′}} + \frac{1}{2} {\sum }_{\{ i , j \text{:} {K}_{ij} = k \}} {( {{E}_{i}^{′}}_{{ }^{- {μ}_{k}^{′}}} )}^{2} )}^{{a}_{{τ}^{′}} + \frac{{n}_{k}}{2}}\end{matrix}}$$

Compute

$${v}_{1} = \frac{( {b}_{τ}^{{a}_{τ}} \cdot {b}_{{τ}^{′}}^{{a}_{{τ}^{′}}} )}{\begin{matrix}{( {b}_{τ} + \frac{1}{4} {\sum }_{\{ i , j \text{:} {K}_{ij} = k \}} {( {E}_{i} - μ )}_{k} )}^{2} + \\ {{( {E}_{j}^{′} - {μ}_{k}^{′} )}^{2} - 2 ( {E}_{i} - {μ}_{k} ) ( {E}_{j}^{′} - {μ}_{k}^{′} ) )}^{{a}_{τ} + \frac{{n}_{k}}{2}} \\ {( {b}_{{τ}^{′}} + \frac{1}{4} {\sum }_{\{ i , j \text{:} {K}_{ij} = k \}} {( {E}_{i} - μ )}_{k} )}^{2} + \\ {{( {E}_{j}^{′} - {μ}_{k}^{′} )}^{2} + 2 ( {E}_{i} - {μ}_{k} ) ( {E}_{j}^{′} - {μ}_{k}^{′} ) )}^{{a}_{{τ}^{′}} + \frac{{n}_{k}}{2}}\end{matrix}}$$

$$Generate v \text{∼} Uniform ( 0 , 1 ) - If \leq \frac{{v}_{0}}{{v}_{0} + {v}_{1}} , put {Ψ}_{k} = 0 otherwise put {Ψ}_{k} = 1$$

Generate (πₖ|μₖ, μ′ₖ, Ψₖ, K₁₁, . . . , K_{nn′}, E₁, E′₁, . . . , Eₙ, E′_{n′}) for k≦κ*,
   If

$${Ψ}_{k} = 0 {τ}_{k}^{- 1} \text{∼} Gamma ( {a}_{τ} + \frac{{n}_{k}}{2} , {b}_{τ} + \frac{1}{2} {\sum }_{\{ i , j \text{:} {K}_{ij} = k \}} {( {E}_{i} - {μ}_{k} )}^{2} )$$

If

$${ψ}_{k} = 1 {τ}_{k}^{- 1} \text{∼} Gamma ( {a}_{τ} + \frac{{n}_{k}}{2} , {b}_{τ} + \frac{1}{4} {\sum }_{\{ i , j \text{:} {K}_{ij} = k \}} {( {E}_{i} - {μ}_{k} )}^{2} + {( {E}_{j}^{′} - {μ}_{k}^{′} )}^{2} - 2 ( {E}_{i} - {μ}_{k} ) ( {E}_{j}^{′} - {μ}_{k}^{′} ) )$$

Generate (τ^{′}ₖ|μₖ, μ′ₖ, Ψₖ, K₁₁, . . . , K_{nn′}, E₁, E′₁, . . . , Eₙ, E′_{n′}) for k≦κ*,
   If

$${ψ}_{k} = 0 {{τ}^{′}}_{k}^{- 1} \text{∼} Gamma ( {a}_{{τ}^{′}} + \frac{{n}_{k}}{2} , {b}_{{τ}^{′}} + \frac{1}{2} {\sum }_{\{ i , j \text{:} {K}_{ij} = k \}} {( {E}_{j}^{′} - {μ}_{k}^{′} )}^{2} )$$

If

$${ψ}_{k} = 1 {τ}_{k}^{- 1} \text{∼} Gamma ( {a}_{τ} + \frac{{n}_{k}}{2} , {b}_{{τ}^{′}} + \frac{1}{4} {\sum }_{\{ i , j \text{:} {K}_{ij} = k \}} {( {E}_{i} - {μ}_{k} )}^{2} + {( {E}_{j}^{′} - {μ}_{k}^{′} )}^{2} + 2 ( {E}_{i} - {μ}_{k} ) ( {E}_{j}^{′} - {μ}_{k}^{′} ) )$$

Generate (\vec{μ}ₖ|τₖ, τ′ₖ, Ψₖ, K₁₁, . . . , K_{nn′}, E₁, E′₁, . . . , Eₙ, E′_{n′}) for k≦κ*,
   Compute S_{μ}_{ₖ}=(Σ_{{ij: K}_{ᵢⱼ}_{=k}}Eᵢ, Σ_{{ij: K}_{ᵢⱼ}_{=k}}E′ⱼ)^{T}
   Put

$${\sum }_{k} = {R}_{{ψ}_{k}}^{- 1} \cdot ( \begin{matrix}{τ}_{k} & 0 \\ 0 & {τ}_{k}^{′}\end{matrix} ) \cdot {R}_{{ψ}_{k}} with {R}_{{ψ}_{k}} = ( \begin{matrix}1 & 0 \\ 0 & 1\end{matrix} ) if {ψ}_{k} = 0 and {R}_{{ψ}_{k}} = \frac{\sqrt{2}}{2} ( \begin{matrix}1 & - 1 \\ 1 & 1\end{matrix} ) if {ψ}_{k} = 1$$

Compute V_{μ}_{ₖ}=(┌_{μ}⁻¹=nₖ Σₖ⁻¹)⁻¹
Compute M_{μ}_{ₖ}=V_{μ}_{ₖ}•(┌_{μ}⁻¹•\vec{m}_{μ}+Σₖ⁻¹•S_{μ}_{ₖ})
Generate \vec{μ}ₖ˜N₂(M_{μ}_{ₖ}, V_{μ}_{ₖ})
Generate (βₖ|μₖ, μ′ₖ, τₖ, τ′ₖ, Ψₖ, K₁₁, . . . , K_{nn′}, E₁, E′₁, . . . Eₙ, E′_{n′}, y₁₁, . . . , y_{nn′}) for k≦κ*,
   Put

$${Γ}_{{β}_{k}} = {( {\sum }_{\{ ij : {K}_{ij} = k \}} {{\tilde{X}}_{k} ( {\vec{E}}_{ij} )}^{T} \cdot {\tilde{X}}_{k} ( {\vec{E}}_{ij} ) \cdot {e}^{- {y}_{ij}} + {Γ}_{β}^{- 1} )}^{- 1}$$

Put

$${M}_{{β}_{k}} = {Γ}_{{β}_{k}} \cdot ( {\sum }_{\{ ij : {K}_{ij} = k \}} {\tilde{X}}_{k} ( {\vec{E}}_{ij} ) \cdot {y}_{ij} \cdot {e}^{- {y}_{ij}} + {Γ}_{β}^{- 1} \cdot {M}_{β} )$$

Generate βₖ ˜ N_{|\tilde{X}(\vec{E})|}M_{β}_{ₖ}, ┌_{β}_{ₖ}).

For this random draw, the variance of observation of yᵢⱼ (itself approximated with a Gaussian random variable) σᵢⱼ²=e^{-β}^{ₖ}^{^{T}}^{·\tilde{X}}^{ₖ}^{(\vec{E}}^{ᵢⱼ}⁾ is approximated with the value of the corresponding Poisson observation λᵢⱼ=e^{-y}^{ᵢⱼ}. The higher is λᵢⱼ, the more valid is this approximation, which greatly simplifies the inference.
Compute at each iteration (t) for any choice of prediction grid \vec{E}=(E, E′),

$${S ( E , {E}^{′} )}^{( t )} = ( y \vert E , {E}^{′} ) = {\sum }_{k = 1}^{∞} \frac{{w}_{k} {2}_{} ( \vec{E} \vert {\vec{μ}}_{k} , {Σ}_{k} )}{{\sum }_{l = 1}^{∞} {w}_{l} {2}_{} ( \vec{E} \vert {\vec{μ}}_{l} , {Σ}_{l} )} {β}_{k}^{′} \cdot {\tilde{X}}_{k} ( \vec{E} )$$

The denoised spectral response can, by choice, share or otherwise the same grid (Eᵢ, E′ⱼ) as the initial physical Monte-Carlo simulation. Indeed, the user can choose any point (E, E′) of interest. In particular, it is possible to interpolate between the points of the initial grid.

Finally, on the basis of T iterations of the Gibbs sampler, we obtain an estimation of the meta-model for the spectrometry

$$\hat{S} ( E , {E}^{′} ) \approx \frac{1}{T} {\sum }_{t = 1}^{T} {S ( E , {E}^{′} )}^{( t )}$$

It is then possible to compute the a posteriori standard deviation of the spectral response estimator

$${σ}_{\hat{S} ( E , {E}^{′} )} \approx ( \frac{1}{T - 1} {\sum }_{t = 1}^{T} {( \hat{S} ( E , {E}^{′} ) - {S ( E , {E}^{′} )}^{( t )} )}^{2} ) \cdot \frac{1}{2}$$

The hyper parameters may be considered fixed in the estimation of the response of the spectrometric system as a function of prior physical knowledge about the detector. On the other hand, they may be estimated by means of an additional level of hierarchy which makes it possible to allocate them a, so-called vague, a priori.
By way of example, it is possible to place an a priori Gamma(φ_{b}, ξ_{b}) on the scale parameters b_{τ} and b′_{τ} in the distribution of the amplitudes of components. This choice leads to a Gamma a posteriori distribution. Example:

$${b}_{τ} ∼ Gamma ( {ϕ}_{b} + {κ}_{n} , {ξ}_{b} + {\sum }_{k = 1}^{{κ}_{n}} \frac{1}{{τ}_{k}} ) .$$

It may be relevant to estimate the concentration parameter α of the Dirichlet process by following the approach of Escobar and West (1995).
The parameter ρ of Bernoulli's law involved in the mixture model of the type of component Ψₖ may itself be estimated by way of a hyperprior Beta(π₀, π₁). The a posteriori law for ρ then follows the expression:

ρ˜ Beta(π₀+#{k≦κₙ : Ψₖ=0}, π₁+#{k≦κₙ : Ψₖ=1})
We note also that it may be efficient to replace the Gaussian a priori on the regression coefficients βₖ by a so-called empirical a priori based on the random drawing of P points (\tilde{E}₁, [symbol] ₁, . . . , \tilde{E}_{P}, [symbol] _{P}) on the basis of N₂(\vec{μ}ₖ, Σₖ) and to take for (\tilde{y}₁, . . . , \tilde{y}_{P}) the closest value of yᵢⱼ corresponding to each sampled point. P must be larger than the size of the vector βₖ. We then generate βₖ ˜ N(M_{β}, Γ_{β}) as a priori law (with \vec{E}ₚ=(\tilde{E}ₚ, [symbol] ₚ)):

$${Γ}_{β} = {( {\sum }_{p = 1}^{P} {{\tilde{X}}_{k} ( {\vec{E}}_{p} )}^{T} \cdot {\tilde{X}}_{k} ( {\vec{E}}_{p} ) \cdot {e}^{- {\tilde{y}}_{p}} )}^{- 1}$$

$${M}_{β} = {Γ}_{β} \cdot ( {\sum }_{p = 1}^{P} {\tilde{X}}_{k} ( {\vec{E}}_{p} ) {\tilde{y}}_{p} {e}^{- {\tilde{y}}_{p}} ) .$$

The expression for the a posteriori law of βₖ flows directly therefrom.

On completion of these various steps, the method has a continuous meta-model characterizing any type of detector for nuclear spectrometry, the meta-model taking into consideration all of the physical interactions involved in the spectral response for a given input energy.

The meta-model thus generated will be able to be injected into a nuclear spectrum convolution scheme using a non-parametric probabilistic modeling such as that proposed by Barat et al. 2007 (Barat, E.; Dautremer, T.; Montagu, T., “Nonparametric bayesian inference in nuclear spectrometry,” Nuclear Science Symposium Conference Record, 2007. NSS '07. IEEE, vol.1, no., pp.880-887, Oct. 26 2007-Nov. 3 2007), in order to determine the radioelements present in the spectrum and their activity.

As a function of the environment in which the object to be analyzed is situated, spectral signature shape variations may occur which are due to the presence of matrix effects at the input source level. The meta-model defined according to the invention can take several estimated spectral responses into consideration, as was explained hereinabove. Accordingly, a solution consists for example in using various shieldings of various thicknesses and of various materials, to be simulated and involved in the meta-model.

Another solution consists in preserving a Polya tree to model the diffuse interactions leading to continuous backgrounds which might not be modeled in the response.

Under the assumption that the meta-model takes into consideration a collection of matrix effects, as described previously, the input spectrum sought then consists only of discrete peaks. It is then possible to substitute, for the a priori by Dirichlet process on monoenergetic spectral lines, an a priori by Dirichlet process on the radioelements of a database of radionuclides. The spectrum sought then consists of a discrete sum of elements of the periodic table whose number of components is unlimited. It then becomes possible to assign each radioelement an a priori probability of presence in the analyzed sample. The meta-model is again used to characterize the spectral response of the detector of the element considered. This response is directly determined by the discrete sum of the individual spectral responses corresponding to each monoenergetic spectral line considered. The use of a database of radionuclides makes it possible in particular to consider the calibration in terms of energy of the observed spectrum to be uncertain and to estimate it on the basis of the data. For each proposed value of keV/channel it is necessary to evaluate the spectral response of the system for each energy of the output grid. This operation uses the continuous meta-model, thus eliminating any need for interpolations in the case of recourse to a discrete model.

In the case where the meta-model takes a collection of matrix effects into consideration, to directly estimate the activity of the radionuclides, use is made of an extended meta-model denoted S(E, E′, ξ) where ξ represents a parameter characteristic of the matrix effect associated with the source. The collection of matrix effects is discrete of size M and each element ξ is identified by an integer index.

The algorithm for estimating the activities is based on a Markov chain Monte-Carlo (MCMC) approach and more particularly on a Gibbs sampler, an example of which is detailed hereinafter.

Before explicitly describing the algorithm, various parameters are set. The spectrum is considered to be a Dirichlet process mixture of various normalized radionuclide responses. An exemplary construction of this mixture is given hereinafter.

An arbitrary radionuclide of a given table of radioelements is denoted χ. This table being discrete, each element will be labeled hereinafter by an integer index. We denote by N_{χ} the number of emitters retained for the element x considered and by π_{χ,l} for l=1, . . . , N_{χ} the associated emission probabilities as well as by v_{χ,l} for l=1, . . . , N_{χ} the corresponding energies. The response of the radionuclide Ψ_{χ}(E′, ξ), for an observed energy E′ and a matrix effect is defined by:

$${ψ}_{χ , ξ} ( {E}^{′} ) = {\sum }_{l = 1}^{{N}_{χ}} {π}_{χ , l} S ( {v}_{χ , l} , {E}^{′} , ξ ) ,$$

we define

$${Λ}_{χ , ξ} = {\int }_{0}^{∞} {ψ}_{χ , ξ} ( {E}^{′} ) {dE}^{′} and {π}_{χ , l , ξ}^{*} = \frac{{π}_{χ , l}}{{Λ}_{χ , ξ}}$$

for all l=1, . . . , N_{χ}. A normalized radionuclide response is then defined by:

$${ψ}_{χ , ξ}^{*} ( {E}^{′} ) = {\sum }_{l = 1}^{{N}_{χ}} {π}_{χ , l , ξ}^{*} S ( {v}_{χ , l} , {E}^{′} , ξ ) ,$$

it may be verified that ∫₀^{∞} Ψ*_{χ,ξ}(E′)dE′=1

The probability density of the i^{th} photon observed in the energy channel E′ᵢ is then expressed for i=1, n:

$$f ( {E}_{i}^{′} ) = {\sum }_{k = 1}^{∞} {w}_{k} {ψ}_{{χ}_{k} , {ξ}_{k}}^{*} ( ρ . {E}_{i}^{′} )$$

where ρ is a positive parameter for converting the channel index into energy ( keV/channel). We suggest for ρ a Gaussian a priori centered on μ_{ρ} and of standard deviation σ_{ρ}:

ρ ˜ [symbol] (ρ|μ_{ρ}, σ_{ρ}²)

This Dirichlet process mixture relies on the probability measure F generated according to a Dirichlet process:

F ˜ DP(α, F_{χ}⁰×F_{ξ}⁰)
F_{χ}⁰(χ)=Σⱼ₌₁^{J} pⱼ⁰ δⱼ(χ) represents the a priori probability distribution of observing an element χ where J is the number of radionuclides of the base retained for the analysis and pⱼ⁰≧0. F_{ξ}⁰ is the discrete uniform a priori law on the collection of matrix effects, and α is the (positive) concentration parameter of the process:

$$F ( \cdot ) = {\sum }_{k = 1}^{∞} {w}_{k} {δ}_{{χ}_{k} , {ξ}_{k}} ( \cdot )$$

with w₁=V₁, wₖ=VₖΠₗ₌₁^{k-1}(1−Vₗ) such that Vₖ˜Beta(1, α) and δᵤ(•) represents the localized Dirac function in u.

Before describing the various random draws making it possible to explore the a posteriori law, it remains to introduce the variables Kᵢ for allocating the i^{th} photon observed to a component k of the mixture.

The Gibbs sampler consists in alternating random draws according to the following conditional laws, for all i≦n,

Kᵢ|E′ᵢ, w₁, w₂, . . . , χ₁, χ₂, . . . , ξ₁, ξ₂, . . . , ρ
and for all k

w₁, w₂, . . . |K₁, . . . , Kₙ

χₖ|K₁, . . . , Kₙ, E′₁, . . . , E′ₙ, ξ₁, ξ₂, . . . , ρ

ξₖ|K₁, . . . , Kₙ, E′₁, . . . , E′ₙ, χ₁, χ₂, . . . , ρ
as well as

ρ|K₁, . . . , Kₙ, E′₁, . . . , E′ₙ, χ₁χ₂, . . . , ξ₁, ξ₂, . . .

Just as for the determination of the meta-model, in order to minimize the number of computations, the approach proposed by (Kalli et al. 2011) and the introduction of an auxiliary variable uᵢ which makes it possible to generate only a finite random number κ of components at the iteration (t) while avoiding an arbitrary truncation of the model are used. Under these assumptions, the various steps of random generation of the algorithm are detailed hereinafter.

### Random Initialization.

Generate for 1≦i≦n, uᵢUniform(0, 1/n), and

$$put {u}^{*} = {min}_{u} ( \{ {u}_{i} \} )$$

Generate V₁˜Beta(1, α); put w₁=V₁ and r₁=1−V₁.
For k>1, generate Vₖ˜Beta(1, α), put wₖ=Vₖrₖ₋₁, and put rₖ=rₖ₋₁(1−Vₖ), as long as rₖ≧u*.
Assign the maximum value of k to κ*.
Generate χₖ for 1≦k≦κ*, on the basis of the a priori distribution F_{χ}⁰.
Generate ξₖ for 1≦k≦κ*, on the basis of the a priori distribution F_{ξ}⁰.
Generate ρ ˜ N(ρ|μ_{ρ}, σ_{ρ}²).
At iteration t=1, . . . , T,
   Generate (Kᵢ|Eᵢ, w₁, w₂, . . . , χ₁, χ₂, . . . ξ₁, ξ₂, . . . , ρ) for i≦n,
      Compute for 1≦k≦κ*,
      λₖ=1(wₖ>max(wₖ, 1/n)Ψ*_{χk·ξk}(ρE′ᵢ) where 1(A) is the indicator function:
      1(A)=1 if A is true and 1(A)=0 otherwise.
      Generate

$${K}_{i} ∼ \frac{1}{{\sum }_{k = 1}^{{K}^{*}} {λ}_{k}} {\sum }_{k = 1}^{{K}^{*}} {λ}_{k} {δ}_{k} ( {K}_{i} ) .$$

Reorder the tags of components by following their order of occurrence in the generation of the Kᵢ. Assign the number of distinct values of Kᵢ to κₙ. Put, for all k≦κₙ, nₖ=#{Kᵢ=k}, the number of observations E′ᵢ assigned to the component k.
Generate (w₁, w₂, . . . , u₁, . . . , uₙ|K₁, . . . , Kₙ)
Generate (w₁, w₂, w_{κ}_{ₙ}, r_{κ}_{ₙ}) ˜ Dirichlet(n₁, n₂, . . . , n_{κ}_{ₙ}, α).
Generate for i≦n, uᵢ˜Uniform(0,min(wₖ, 1/n)).
Put

$${u}^{*} = {min}_{u} ( \{ {u}_{i} \} ) .$$

For k>κₙ, generate Vₖ˜Beta(1, α), put wₖ=Vₖrₖ₋₁, put rₖ=rₖ₋₁(1−Vₖ), as long as rₖ≧u*,
Assign the maximum value of k to κ*.
Generate (χₖ|K₁, . . . , Kₙ, E′₁, . . . , E′ₙ, ξ₁, ξ₂, . . . , ρ) for k≦κ*,
Compute for all

$$j = 1 , … , J , \\ {η}_{k , j} = {p}_{j}^{0} {Π}_{{K}_{i} = k}^{i} {ψ}_{j , {ξ}_{k}}^{*} ( ρ {E}_{i}^{′} ) ,$$

Generate

$${χ}_{k} ∼ \frac{1}{{\sum }_{j = 1}^{J} {η}_{k , j}} {\sum }_{j = 1}^{J} {η}_{k , j} {δ}_{j} ( {χ}_{k} ) .$$

Generate (ξₖ|K₁, . . . , Kₙ, E′₁, . . . , E′ₙ, χ₁, χ₂, . . . , ρ) for k≦κ*,
Compute for all

$$m = 1 , … , M , \\ {ζ}_{k , m} = {\prod }_{{i}_{{K}_{i} = k}} {ψ}_{{χ}_{k ,} m}^{*} ( ρ {E}_{i}^{′} ) .$$

Generate

$${ξ}_{k} ∼ \frac{1}{{\sum }_{m = 1}^{M} {ζ}_{k , m}} {\sum }_{m = 1}^{M} {ζ}_{k , m} {δ}_{m} ( {ξ}_{k} ) .$$

Generate (ρ|K₁, . . . , Kₙ, E′₁, . . . , E′ₙ, χ₁, χ₂, . . . , ξ₁, ξ₂, . . . ) by a Metropolis-Hastings step,
Generate a random walk with standard deviation ε_{ρ} around ρ

ρ*˜ [symbol] (ρ*|ρ, ε_{ρ}²).
Compute

$${ϱ}_{MH} = \frac{ ( {ρ}^{*} \vert {μ}_{ρ} , {σ}_{ρ}^{2} ) {\prod }_{i = 1}^{n} {ψ}_{{χ}_{{K}_{i}} , {ξ}_{{K}_{i}}}^{*} ( {ρ}^{*} {E}_{i}^{′} )}{ ( ρ \vert {μ}_{ρ} , {σ}_{ρ}^{2} ) {\prod }_{i = 1}^{n} {ψ}_{{χ}_{{K}_{i}} , {ξ}_{{K}_{i}}}^{*} ( ρ {E}_{i}^{′} )}$$

Generate a uniform variable v ˜ Uniform(0,1).
If v≦min( [symbol] ) assign ρ=ρ*, otherwise leave p unchanged.
Finally, on the basis of T iterations of the Gibbs sampler, we obtain an estimation of the activities of the radioelements involved in the mixture, for all k,

$$\approx \frac{1}{T} {\sum }_{t = 1}^{T} {w}_{k}^{( t )} {Λ}_{{χ}_{k} , {ξ}_{k}}^{( t )}$$

Additionally, it is also immediate to compute the a posteriori standard deviation of the activities:

$$\approx {( \frac{1}{T - 1} {\sum }_{t = 1}^{T} {( - {w}_{k}^{( t )} {Λ}_{{χ}_{k} , {ξ}_{k}}^{( t )} )}^{2} )}^{\frac{1}{2}} \qquad$$

It is also possible to obtain the estimated input spectrum, deconvolved of the response of the system

$$\approx \frac{1}{T} {\sum }_{t = 1}^{T} {w}_{k}^{( t )} {\sum }_{l = 1}^{{N}_{{χ}_{k}^{( t )}}} {π}_{{χ}_{k}^{( t )} , l , {ξ}_{k}^{( t )}}^{*} {δ}_{{v}_{{χ}_{k}^{( t )} , l}} ( E )$$

In the proposed version the algorithm allows the estimation of the conversion gain keV/channel on the basis solely of the data as well as the determination of a matrix effect (potentially different) for each element involved in the mixture. It also makes it possible to fix an a priori probability of occurrence of the radionuclides in the context considered and to directly obtain the activities of the constituent elements of the mixture as well as the associated uncertainties.

FIGS. 9 and 10 illustrate the spectrum of the energies which is obtained on the basis of the analysis of the spectrum of FIG. 10 by using the method according to the invention. The dotted curve represents the simulated spectrum, the solid curve the reconstructed spectrum.

FIGS. 11 and 12 illustrate a second exemplary spectrum. FIG. 11 represents the spectrum of the incident energies, with a region of emission of the first peak at ⁶⁰Co, 1173.2 keV. FIG. 12 the same spectrum with a zoom on the region of interest.

1. A method for determining the nature of the radioelements present in an object and their activity, comprising at least the following steps:
a first phase of numerical simulation of spectrometric responses for an incident-energy set E and a measured-output-energy set E′, so as to obtain a simulated-data set,
a second phase of non-parametric regression on the simulated data, non-parametric estimation of the quantity representing the joint probability of the triplets (E, E′,y) on the basis of simulated points (Ei,Ei′,yij) so as to deduce therefrom a meta-model S(E, E′) for any energy pair (E, E′) on a continuous function,
use is made of n a number of points in the input grid, energies E, and n′ a number of points in the output grid, energies E′,
for i=1, . . . , n and j=1, . . . , n′, the data characteristic of the computed spectral intensities λᵢⱼ for an input energy Eᵢ and an output energy E′ⱼ are available,
use is made of a non-parametric scheme for estimating the quantity f(E, E′, y), representing the joint probability density of the triplets (E, E′, y) on the basis of the simulated points (Eᵢ, E′ⱼ, yᵢⱼ), and a model S(E, E′) is deduced for all (E, E′) ∈ R² where R is a continuous space:
$$S ( E , {E}^{′} ) = ( y \vert E , {E}^{′} ) = y \cdot f ( y \vert E , {E}^{′} ) dy = \frac{ y \cdot f ( E , {E}^{′} , y ) dy}{ f ( E , {E}^{′} , y ) dt}$$
where the symbol E(y) represents the mathematical expectation of the random variable y, y is deduced from the computed spectral intensities λᵢⱼ,
on the basis of the meta-model S(E, E′), (36) the determination of the nature and activity of the radioelements present in the object.

2. The method as claimed in claim 1, wherein the values λᵢⱼ are determined by using a Monte-Carlo software package, the data λᵢⱼ being considered to be realizations arising from a Poisson distribution whose intensity Iᵢⱼ is estimated by means of a non-parametric regression procedure and we introduce yᵢⱼ=log(λᵢⱼ+ε) where 0<ε<<1, and then
we approximate the probability distribution of yᵢⱼ for sufficiently large values of Iᵢⱼ>10 by a Gaussian law with mean log Iᵢⱼ and variance
$$\frac{1}{{I}_{ij}} ,$$
for the joint law f(E, E′, y), a Dirichlet process mixture (DPM) is chosen as a priori distribution and the random distribution is expressed as a sum over infinity of f_{θ}_{ₖ} the components of f(E, E′, y),
$$f ( E , {E}^{′} , y ) = {\sum }_{k = 1}^{∞} {w}_{k} {f}_{{θ}_{k}} ( E , {E}^{′} , y )$$
parametrized by θₖ the parameter associated with the k^{th} component of G a random measure defined by
$$G ( \cdot ) = {\sum }_{k = 1}^{∞} {w}_{k} {δ}_{{θ}_{k}} ( \cdot )$$
w₁=V₁, wₖ=VₖΠₗ₌₁^{k-1}(1−Vₗ) such that Vₖ˜Beta(1, α) and δᵤ(•) represents the localized Dirac function in u and Beta(a, b), for 0≦x≦1 with
$${f}_{Beta ( a , b )} ( x ) = \frac{Γ ( a + b )}{Γ ( a ) Γ ( b )} {{x}^{a - 1} ( 1 - x )}^{b - 1} .$$

3. The method as claimed in claim 2, wherein the components of the joint law f_{θ}_{ₖ} are expressed on the basis of the following values:
θₖ=(\vec{μ}ₖ, \vec{τ}ₖ, Ψₖ, βₖ) with \vec{μ}ₖ=(μₖ, μ′ₖ), \vec{τ}ₖ=(τₖ, τ′ₖ),
\tilde{X}ₖ(\vec{E}) the centered vector of regressors with \vec{E}=(E, E′), and βₖ the vector of regression coefficients,
the matrix Σₖ, dependent on the parameter Ψₖ ∈ {0,1}, as follows:
$${Σ}_{k} = {R}_{{ψ}_{k}}^{- 1} \cdot ( \begin{matrix}{τ}_{k} & 0 \\ 0 & {τ}_{k}^{′}\end{matrix} ) \cdot {R}_{{ψ}_{k}} with {R}_{{ψ}_{k}} = ( \begin{matrix}1 & 0 \\ 0 & 1\end{matrix} ) if {ψ}_{k} = 0 and$$
$${R}_{{ψ}_{k}} = \frac{\sqrt{2}}{2} ( \begin{matrix}1 & - 1 \\ 1 & 1\end{matrix} ) if {ψ}_{k} = 1 ,$$
making it possible to choose between a component aligned with the axes E and E′ (Ψₖ=0) and an oblique component oriented by the straight line E=E′ (Ψₖ=1),
each component fₒₖ is then expressed:
f_{θ}_{ₖ}(E, E′, y)= [symbol] ₂(\vec{E}|\vec{μ}ₖ, Σₖ) [symbol] (y|βₖ^{T}·\tilde{X}ₖ(\vec{E}), e^{-β}^{ₖ}^{^{T}}^{·\tilde{X}}^{ₖ}^{(\vec{E})})
where N(•|μ, σ²) represents the Gaussian law of μ and of variance σ², N₂(• |\vec{μ}, Σ) the bivariate Gaussian law with mean \vec{μ} ∈ R² and with covariance matrix Σ, where the a priori law for the parameter μₖ is a Gaussian, the variance τₖ is distributed according to an inverse-gamma law, Ψₖ follows an a priori law of Bernoulli type and the a priori for the regression coefficients βₖ is a multivariate normal (Gaussian) law of dimension |\tilde{X}(\vec{E})|, and
by applying a Bayes' rule to the expression for f(E, E′, y) we obtain the expression
$$f ( y \vert E , {E}^{′} ) = {\sum }_{k = 1}^{∞} \frac{{w}_{k} {2}_{} ( \vec{E} \vert {\vec{μ}}_{k} , {Σ}_{k} )}{{\sum }_{l = 1}^{∞} {w}_{l} {2}_{} ( \vec{E} \vert {\vec{μ}}_{l} , {Σ}_{l} )} ( y \vert {β}_{k}^{T} \cdot {\tilde{X}}_{k} ( \vec{E} ) , {e}^{- {β}_{k}^{T} \cdot {\tilde{X}}_{k} ( \vec{E} )} )$$
and the probabilistic model
$$S ( E , {E}^{′} ) = ( y \vert E , {E}^{′} ) = {\sum }_{k = 1}^{∞} \frac{{w}_{k} {2}_{} ( \vec{E} \vert {\vec{μ}}_{k} , {Σ}_{k} )}{{\sum }_{l = 1}^{∞} {w}_{l} {2}_{} ( \vec{E} \vert {\vec{μ}}_{l} , {Σ}_{l} )} {β}_{k}^{′} \cdot {\tilde{X}}_{k} ( \vec{E} ) \qquad$$
on the basis of this probabilistic model and of the data observed by simulation (Eᵢ, E′ⱼ, yᵢⱼ) we estimate the a posteriori law f(E, E′, y|E₁, E′₁, y₁₁, . . . , Eₙ, E′_{n′}, y_{nn′}) and the conditional expectation \tilde{S}(E, E′)=E(y|E, E′, E₁, E′₁, y₁₁, . . . , Eₙ, E′_{n′}, y_{nn′}) so as to determine the elements present in the object and their activity.

4. The method as claimed in claim 3, wherein for the computation of the a posteriori, a Markov chain Monte-Carlo (MCMC) approximation scheme is used,
for any iteration (t) of the MCMC procedure, a denoised spectral response S(E, E′)^{(t)} is generated,
for T generations, the a posteriori distribution of the spectral response is approximated by the set of draws S(E, E′)^{(t)} for t=1, . . . , T, and the estimated response is expressed:
$$\hat{S} ( E , {E}^{′} ) \approx \frac{1}{T} {\sum }_{t = 1}^{T} {S ( E , {E}^{′} )}^{( t )}$$

5. The method as claimed in claim 4, wherein the approximation scheme comprises a step of slice-wise sampling using a finite random number x of components for each iteration and in that it comprises the following steps:
we introduce latent classification variables Kᵢⱼ, defined for i=1, . . . , n and j=1, . . . , n′, such that Kᵢ=k if (Eᵢ, E′ⱼ, yᵢⱼ) is distributed according to the k^{th} component of the mixture f(E, E′, y), we define a model for the parameters of the mixture,
for all i≦n, j≦n′,
$${K}_{ij} \vert {w}_{1} , {w}_{2} , … \sim {{\sum }_{k = 1}}^{∞} {w}_{k} {δ}_{k} ( \cdot )$$
$${E}_{i} , {E}_{j}^{′} \vert {K}_{ij} , {θ}_{1} , {θ}_{2} , … \sim {𝒩}_{2} ( {E}_{i} , {E}_{j}^{′} \vert {\vec{μ}}_{{K}_{ij}} , {\sum }_{{K}_{ij}} )$$
$$with {\vec{μ}}_{{K}_{ij}} = ( {μ}_{{K}_{ij}} , {μ}_{{K}_{ij}}^{′} ) , {\sum }_{{K}_{ij}} = {R}_{{ψ}_{{K}_{ij}}}^{- 1} \cdot ( \begin{matrix}{τ}_{{K}_{ij}} & 0 \\ 0 & {τ}_{{K}_{ij}}^{′}\end{matrix} ) \cdot {R}_{{ψ}_{{K}_{ij}}}$$
$${y}_{ij} \vert {K}_{ij} , {E}_{i} , {E}_{j}^{′} , {θ}_{1} , {θ}_{2} , … \sim 𝒩 ( {y}_{ij} \vert {β}_{{K}_{ij}}^{T} \cdot {\tilde{X}}_{{K}_{ij}} ( {E}_{i} , {E}_{j}^{′} ) , {e}^{- {β}_{{K}_{ij}}^{T} \cdot {\tilde{X}}_{{K}_{ij} ( {E}_{i} , {E}_{j}^{′} )}} )$$
equivalent to the likelihood
f(K₁₁, . . . , K_{nn′}, E₁, E′₁, . . . , Eₙ, E′_{n′}, y₁₁, . . . , y_{nn′}|w₁, w₂, . . . , θ₁, θ₂, . . . )
on the basis of these probability distributions and by applying Bayes' rule, we compute the conditional probability density
f(w₁, w₂, . . . , θ₁, θ₂, . . . |K₁₁, . . . , K_{nn′}, E₁, E′₁, . . . , Eₙ, E′_{n′}, y₁₁, . . . , y_{nn′})
by using a Gibbs sampler which at each iteration (t) successively generates the following samples, for all k,
w₁, w₂, . . . |K₁₁, . . . , K_{nn′}
Ψₖ|μₖ, μ′ₖ, K₁₁, . . . , K_{nn′}, E₁, E′₁, . . . , Eₙ, E′_{n′}
τₖ|μₖ, μ′ₖ, Ψₖ, K₁₁, . . . , K_{nn′}, E₁, E′₁, . . . , Eₙ, E′_{n′}
τ′ₖ|μₖ, μ′ₖ, Ψₖ, K₁₁, . . . , K_{nn′}, E₁, E′₁, . . . , Eₙ, E′_{n′}
μₖ, μ′ₖ|τₖ, τ′ₖ, Ψₖ, K₁₁, . . . , K_{nn′}, E₁, E′₁, . . . , Eₙ, E′_{n′}
βₖ|μₖ, μ′ₖ, τₖ, τ′ₖ, Ψₖ, K₁₁, . . . , K_{nn′}, E₁, E′₁, . . . , Eₙ, E′_{n′}, y₁₁, . . . , y_{nn′}
and at the level of the numbers of points i in the energy input grid and of points j in the output grid, for all i≦n, j≦n′,
Kᵢⱼ|Eᵢ, E′ⱼ, yᵢⱼ, μ₁, μ₂, . . . , μ′₁, μ′₂, . . . , τ₁, τ₂, . . . , τ′₁, τ′₂, . . . , β₁, β₂, . . . , Ψ₁, Ψ₂, . . . , w₁, 2₂, . . .
on the basis of T iterations of the Gibbs sampler, we obtain an estimation of the meta-model for the spectrometry:
$$\hat{S} ( E , {E}^{′} ) \approx \frac{1}{T} {\sum }_{t = 1}^{T} {S ( E , {E}^{′} )}^{( t )} .$$

6. The method as claimed in claim 5, wherein an auxiliary variable uᵢⱼ is introduced so as to generate only a finite random number κ of components at the iteration (t) while avoiding an arbitrary truncation of the model.

7. The method as claimed in claim 4, comprising a step of computing the a posteriori standard deviation and credible intervals on the basis of the set {S(E, E′)^{(t)}}
$${σ}_{\hat{S} ( E , {E}^{′} )} \approx {( \frac{1}{T - 1} {\sum }_{t = 1}^{T} {( \hat{S} ( E , {E}^{′} ) - {S ( E , {E}^{′} )}^{( t )} )}^{2} )}^{\frac{1}{2}} .$$

8. The method as claimed in claim 1, wherein an a priori Gamma(φ_{b}, ξ_{b}) on the scale parameters b₉₆ and b′_{τ} is introduced into the distribution of the amplitudes of components leading to a Gamma a posteriori distribution:
$${b}_{τ} \sim Gamma ( {ϕ}_{b} + {κ}_{n} , {ξ}_{b} + {\sum }_{k = 1}^{{κ}_{n}} \frac{1}{{τ}_{k}} )$$
with Gamma(a, b), for x≧0,
$${f}_{Gamma ( a , b )} ( x ) = \frac{{b}^{a}}{Γ ( a )} {x}^{a - 1} {e}^{- bx} .$$

9. The method as claimed in claim 3, wherein the Gaussian a priori on the regression coefficients βₖ is replaced by an a priori based on the random drawing of P points (\tilde{E}₁, [symbol] ₁, . . . , \tilde{E}_{P}, [symbol] _{P}) on the basis of N₂(\vec{μ}ₖ, Σₖ) and we take for (\tilde{y}₁, . . . , \tilde{y}_{P}) the closest value of yᵢⱼ corresponding to each sampled point where P is larger than the size of the vector βₖ, we then generate βₖ ˜ N(M_{β}, Γ_{β}) as a priori law (with \tilde{E}ₚ=(\tilde{E}ₚ, [symbol] ₚ))
$${Γ}_{β} = {( {\sum }_{p = 1}^{P} {{\tilde{X}}_{k} ( {\vec{E}}_{p} )}^{T} \cdot {\tilde{X}}_{k} ( {\vec{E}}_{p} ) \cdot {e}^{- {\tilde{y}}_{p}} )}^{- 1}$$
$${M}_{β} = {Γ}_{β} \cdot ( {\sum }_{p = 1}^{P} {\tilde{X}}_{k} ( {\vec{E}}_{p} ) {\tilde{y}}_{p} {e}^{- {\tilde{y}}_{p}} ) .$$

10. The method as claimed in claim 1, wherein we generate an extended meta-model denoted S(E, E′, ξ) where ξ is a parameter identified by an integer index and characteristic of a matrix effect.

11. The method as claimed in claim 1, wherein the activity of the radioelements is estimated by executing the following steps:
let N_{χ} be the number of emitters retained for the element χ considered and let π_{χ,l} for l=1, . . . , N_{χ} be the associated emission probabilities and let v_{χ,l} for l=1, . . . , N_{χ} be the corresponding energies,
the response of the radionuclide Ψ_{χ}(E′, ξ), for an observed energy E′ and a matrix effect is defined by
$${ψ}_{χ , ξ } ( {E}^{′} ) = {\sum }_{l = 1}^{{N}_{χ}} {π}_{χ , l} S ( {v}_{χ , l} , {E}^{′} , ξ )$$
we define
$${Λ}_{χ , ξ} = {\int }_{0}^{∞} {ψ}_{χ , ξ} ( {E}^{′} ) {dE}^{′} and {π}_{χ , l , ξ}^{*} = \frac{{π}_{χ , l}}{{Λ}_{χ , ξ}} for all l = 1 , … , {N}_{χ} ,$$
we define a normalized radionuclide response by
$${ψ}_{χ , ξ}^{*} ( {E}^{′} ) = {\sum }_{l = 1}^{{N}_{χ}} {π}_{χ , l , ξ}^{*} S ( {v}_{χ , l} , {E}^{′} , ξ )$$
it may be verified that ∫₀^{∞}Ψ*_{χ,ξ}(E′)dE′=1
the probability density of the i^{th} photon observed in the energy channel E′ᵢ for i=1, . . . , n is expressed
$$f ( {E}_{i}^{′} ) = {\sum }_{k = 1}^{∞} {w}_{k} {ψ}_{{χ}_{k} , {ξ}_{k}}^{*} ( ρ \cdot {E}_{i}^{′} )$$
where ρ is a positive parameter for converting the channel index into energy (keV/channel),
we introduce the variables Kᵢ for allocating the i^{th} observed photon to a component k of the mixture,
we alternate random draws in accordance with the following conditional laws, for all i≦n,
for all k
w₁, w₂, . . . , |K₁, . . . , Kₙ
χₖ|K₁, . . . , Kₙ, E′₁, . . . , E′ₙ, ξ₁, ξ₂, . . . , ρ
ξₖ|K₁, . . . , Kₙ, E′₁, . . . , E′ₙ, χ₁, χ₂, . . . , ρ
as well as
ρ|K₁, . . . , Kₙ, E′₁, . . . , E′ₙ, χ₁, χ₂, . . . , ξ₁, ξ₂, . . .
by using a finite random number of components at the iteration (t),
on the basis of T iterations of the Gibbs sampler we obtain an estimation of the radioelement activities involved in the mixture for all k,
$$\approx \frac{1}{T} {\sum }_{t = 1}^{T} {w}_{k}^{( t )} {Λ}_{{χ}_{k} , {ξ}_{k }}^{( t )}$$
with ρ a Gaussian a priori centered on μ_{ρ} and of standard deviation σ_{ρ},
ρ ˜ [symbol] (ρ|μ_{ρ}, σ_{ρ}²).

12. The method as claimed in claim 11, wherein we compute the a posteriori standard deviation of the activities
$$\approx {( \frac{1}{T - 1} {\sum }_{t = 1}^{T} {( - {w}_{k}^{( t )} {Λ}_{{χ}_{k} , {ξ}_{k}}^{( t )} )}^{2} )}^{\frac{1}{2}}$$
and/or the estimated input spectrum, deconvolved of the response of the system
$$\approx \frac{1}{T} {\sum }_{t = 1}^{T} {w}_{k}^{( t )} {\sum }_{l = 1}^{{N}_{{χ}_{k}^{( t )}}} {π}_{{χ}_{k}^{( t )} , l , {ξ}_{k}^{( t )}}^{*} {δ}_{{v}_{{χ}_{k}^{( t )} , l}} ( E ) .$$
